(19) United States
(12) Patent Application Publication
(10) Pub. No.: US 2026/0166816 A1
(43) Pub. Date: Jun. 18, 2026

(54) SYSTEMS AND METHODS FOR MONITORING AND CORRECTION OF ADDITIVE MANUFACTURING PROCESSES

(71) Applicant: Align Technology, Inc., San Jose, CA (US)

(72) Inventors: Xirui Peng, Apex, NC (US); Yuxiang Wang, Newark, CA (US); Jun Sato, San Jose, CA (US); Raphael Krobath, Maria Enzersdorf (AT); Robert Gmeiner, Vienna (AT); Wolfgang Steiger, Vienna (AT); Alexander Hochwallner, Vienna (AT); Sonja Baumgartner, Vienna (AT); Peter Mooslechner, Vienna (AT); Thomas Förster-Romswinckel, Pixendorf (AT); Viswanath Meenakshisundaram, Santa Clara, CA (US); Fabian Prasch, Vienna (AT)

(21) Appl. No.: 19/422,257

(22) Filed: Dec. 16, 2025

Related U.S. Application Data
(60) Provisional application No. 63/735,024, filed on Dec. 17, 2024.
(60) Provisional application No. 63/764,813, filed on Feb. 28, 2025.

(51) Int. Cl. B29C 64/393; B33Y 10/00; B33Y 50/02; B33Y 70/00

(52) U.S. Cl. CPC B29C 64/393; B29K 2995/0026; B33Y 10/00; B33Y 50/02; B33Y 70/00

(57) ABSTRACT

Systems and methods for additive manufacturing are provided. In some embodiments, a method includes depositing a curable material on a carrier film, applying energy to the curable material on the carrier film to form a portion of an object, separating the portion of the object from remaining curable material on the carrier film, obtaining image data depicting a recess formed in the remaining curable material by the separation of the portion of the object, and determining a geometry of the portion of the object based on the image data.

### CROSS-REFERENCE TO RELATED APPLICATION(S)

The present application claims the benefit of priority to U.S. Provisional Application No. 63/735,024, filed Dec. 17, 2024, and U.S. Provisional Application No. 63/764,813, filed Feb. 28, 2025, each of which is incorporated by reference herein in its entirety.

### TECHNICAL FIELD

The present technology generally relates to additive manufacturing, and in particular, to systems and methods for monitoring and correction of additive manufacturing processes.

### BACKGROUND

Additive manufacturing encompasses a variety of technologies that involve building up 3D objects from multiple layers of material. However, conventional additive manufacturing systems and devices may be prone to issues that compromise the efficiency, quality, and scalability of the printing process. For instance, conventional additive manufacturing process may be susceptible to accuracy and consistency issues resulting from different printing conditions such as temperature variations, machine-to-machine differences, resin batch-to-batch differences, and part design differences. Conventional additive manufacturing systems and devices may lack the capability to detect and mitigate such issues, and may therefore be unsuitable for large-scale production of printed objects.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIG. 1 is a partially schematic diagram providing a general overview of an additive manufacturing process, in accordance with embodiments of the present technology.

FIG. 2 is a partially schematic side view of a system for additive manufacturing configured in accordance with embodiments of the present technology.

FIG. 3A is a partially schematic side view of a printer assembly including an imaging device near a post-print zone, in accordance with embodiments of the present technology.

FIG. 3B is a perspective view of the post-print zone of the printer assembly of FIG. 3A, in accordance with embodiments of the present technology.

FIGS. 3C-3E illustrate deformation of a carrier film that may occur at the post-print zone of the printer assembly of FIG. 3A, in accordance with embodiments of the present technology.

FIG. 4 is a flow diagram illustrating a method for monitoring and/or correcting additive manufacturing of an object, in accordance with embodiments of the present technology.

FIG. 5 is a perspective view of a portion of a printer assembly showing recesses in a curable material on a carrier film, in accordance with embodiments of the present technology.

FIG. 6 is a flow diagram illustrating a method for monitoring and/or correcting additive manufacturing of an object, in accordance with embodiments of the present technology.

FIGS. 7A-7D illustrate use of projected patterns for visualization of features in a curable material, in accordance with embodiments of the present technology.

FIG. 8 is a flow diagram illustrating a method for monitoring and/or correcting additive manufacturing of an object, in accordance with one embodiment.

FIG. 9A illustrates a representative example of a tooth repositioning appliance configured in accordance with embodiments of the present technology.

FIG. 9B illustrates a tooth repositioning system including a plurality of appliances, in accordance with embodiments of the present technology.

FIG. 9C illustrates a method of orthodontic treatment using a plurality of appliances, in accordance with embodiments of the present technology.

FIG. 10 illustrates a method for designing an orthodontic appliance, in accordance with embodiments of the present technology.

FIG. 11 illustrates a method for digitally planning an orthodontic treatment and/or design or fabrication of an appliance, in accordance with embodiments of the present technology.

### DETAILED DESCRIPTION

The present technology relates to systems and methods for additive manufacturing. In some embodiments, for example, a method of the present technology includes depositing a curable material on a carrier film, applying energy to the curable material on the carrier film to form a portion of an object, separating the portion of the object from the carrier film, obtaining image data depicting a deformation of the carrier film during the separation, and determining a geometry of the portion of the object based on the image data. For instance, the portion of the object may exhibit some adhesion to the carrier film, such that the separation of the object portion from the carrier film exerts “peel-off” forces on the carrier film, resulting in deformation (e.g., stretching, displacement) of the carrier film. The location and extent of the deformation may correlate to the geometry of object portion, thereby allowing for indirect determination of the object geometry by monitoring the shape of the carrier film.

As another example, a method of the present technology can include depositing a curable material on a carrier film, applying energy to the curable material on the carrier film to form a portion of an object, separating the portion of the object from remaining curable material on the carrier film, obtaining image data depicting a recess formed in the remaining curable material by the separation of the portion of the object, and determining a geometry of the portion of the object based on the image data. The geometry (e.g., shape, size) of the recess may correlate to the geometry of the object portion, thereby allowing for indirect determination of the object geometry by monitoring the shape of the recess. Optionally, a pattern (e.g., a grid or line) may be projected onto the remaining curable material to facilitate imaging and identification of the shape of the recess.

The present technology can provide many advantages compared to conventional additive manufacturing systems and methods. For instance, conventional additive manufacturing processes may exhibit reduced consistency and/or accuracy resulting from different printing conditions, such as temperature variations, machine-to-machine differences, resin batch-to-batch differences, and/or part design differences. However, conventional systems may lack the capability to detect when consistency and accuracy issues are occurring and to determine the appropriate adjustments (e.g., adjustments to energy pattern and/or dosage) to compensate for different printing conditions. Furthermore, lack of real-time failure detection may result in greater material waste and manufacturing inefficiencies from reprinting of objects demonstrating non-recoverable failures. Conventional techniques for failure detection such as vision-controlled jetting are generally unsuitable for additive manufacturing using clear resins, since such resins typically have similar refractory indices in the precured and cured state, making it difficult to detect errors in the object geometry via direct imaging of the deposited resin or the printed object.

In contrast, the present technology provides systems and methods that are configured to detect printing errors indirectly, such as via imaging of the substrate supporting the deposited material (e.g., a carrier film) and/or via imaging of the recesses left in the surrounding material by the separation of the printed object from the material. These indirect imaging techniques are compatible with materials that are transparent or translucent (e.g., clear resins) and thus are challenging to observe via direct imaging of the printed object. Alternatively or in combination, the systems and methods herein can implement techniques to improve the visibility objects fabricated from transparent or translucent materials, such as by projecting a pattern onto the material and/or printed object to facilitate visualization of the object geometry. These techniques may also be applied to detect printing errors that may occur during other stages of the additive manufacturing process (e.g., during deposition and coating of the material onto the substrate). If a printing error is detected (e.g., if the actual geometry of the printed object deviates from the intended geometry; if streaks, bubbles, and/or debris are detected in the deposited material), the system can implement the appropriate adjustments to correct the printing error and/or can terminate the printing of any affected objects to prevent the error from propagating to other objects in the same batch. Accordingly, the present technology can improve the efficiency, accuracy, consistency, and cost-effectiveness of additive manufacturing of objects, particularly in large scale industrial applications.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

As used herein, the terms “vertical,” “lateral,” “upper,” “lower,” “left,” “right,” etc., can refer to relative directions or positions of features of the embodiments disclosed herein in view of the orientation shown in the Figures. For example, “upper” or “uppermost” can refer to a feature positioned closer to the top of a page than another feature. These terms, however, should be construed broadly to include embodiments having other orientations, such as inverted or inclined orientations where top/bottom, over/under, above/below, up/down, and left/right can be interchanged depending on the orientation.

The headings provided herein are for convenience only and do not interpret the scope or meaning of the claimed present technology. Embodiments under any one heading may be used in conjunction with embodiments under any other heading.

### I. Monitoring and Correction of Additive Manufacturing Processes

The present technology relates to systems, methods, and devices for monitoring and/or correction of additive manufacturing processes. In some embodiments, the systems herein use one or more imaging devices (e.g., cameras) to obtain image data (e.g., photographs, video) of various aspects of an additive manufacturing process. The image data can be analyzed to detect printing errors, such as inaccuracies in the geometry of a printed object, incomplete separation of the printed object from the surrounding material, improper material deposition, irregularities in the deposited material, etc. If printing errors are present, the system can implement the appropriate corrections, such as correcting the geometry of an erroneously printed object, terminating the printing of an erroneously printed object, adjusting printing parameters (e.g., energy dosage, material deposition) to reduce the likelihood of future printing errors, and/or alerting an operator of the printing error. In some embodiments, the monitoring and correction processes described herein are performed in real-time or near-real-time, thus reducing or minimizing the impact of printing errors across the object batch and/or improving the accuracy and consistency of the printed objects.

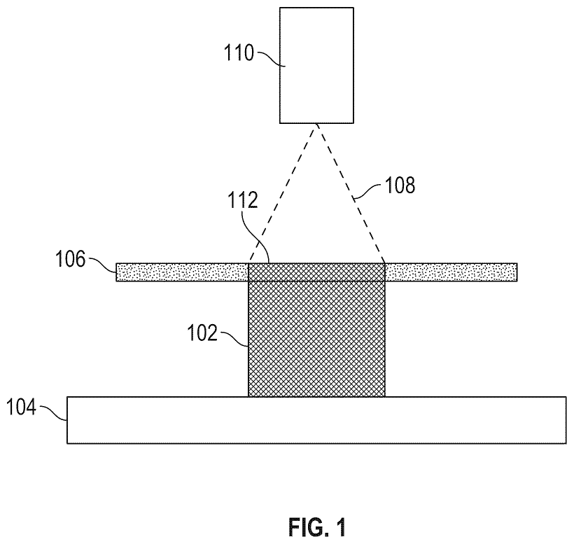

FIG. 1 is a partially schematic diagram providing a general overview of an additive manufacturing process, in accordance with embodiments of the present technology. Additive manufacturing (also referred to herein as “3D printing”) includes a variety of technologies which fabricate 3D objects directly from digital models through an additive process. For example, additive manufacturing can be used to directly fabricate orthodontic appliances (e.g., aligners, palatal expanders, retainers, attachment placement devices, attachments), restorative objects (e.g., crowns, veneers, implants), and/or other dental appliances (e.g., oral sleep apnea appliances, mouth guards). Additional examples of dental appliances and associated methods that are applicable to the present technology are described in Section II below.

In some embodiments, additive manufacturing includes depositing a precursor material (e.g., a polymeric resin) onto a build platform. The precursor material can be cured, polymerized, melted, sintered, fused, and/or otherwise solidified to form a portion of the object and/or to combine the portion with previously formed portions of the object. In some embodiments, the additive manufacturing techniques provided herein build up the object geometry in a layer-by-layer fashion, with successive layers being formed in discrete build steps. Alternatively or in combination, the additive manufacturing techniques described herein can allow for continuous build-up of an object geometry.

For example, in the embodiment of FIG. 1, an object 102 is fabricated on a build platform 104 from a series of cured material layers, with each layer having a geometry corresponding to a respective cross-section of the object 102. To fabricate an individual object layer, a layer of curable material 106 (e.g., polymerizable resin) is brought into contact with the build platform 104 (when fabricating the first layer of the object 102) or with the previously formed portion of the object 102 on the build platform 104 (when fabricating subsequent layers of the object 102). In some embodiments, the curable material 106 is formed on and supported by a substrate (not shown), such as a film. Energy 108 (e.g., light) from an energy source 110 (e.g., a laser, projector, or light engine) is then applied to the curable material 106 to form a cured material layer 112 on the build platform 104 or on the object 102. The remaining curable material 106 can then be moved away from the build platform 104 (e.g., by lowering the build platform 104, by moving the build platform 104 laterally, by raising the curable material 106, and/or by moving the curable material 106 laterally), thus leaving the cured material layer 112 in place on the build platform 104 and/or object 102. The fabrication process can then be repeated with a fresh layer of curable material 106 to build up the next layer of the object 102.

The illustrated embodiment shows a “top down” configuration in which the energy source 110 is positioned above and directs the energy 108 down toward the build platform 104, such that the object 102 is formed on the upper surface of the build platform 104. Accordingly, the build platform 104 can be incrementally lowered relative to the energy source 110 as successive layers of the object 102 are formed. In other embodiments, however, the additive manufacturing process of FIG. 1 can be performed using a “bottom up” configuration in which the energy source 110 is positioned below and directs the energy 108 up toward the build platform 104, such that the object 102 is formed on the lower surface of the build platform 104. Accordingly, the build platform 104 can be incrementally raised relative to the energy source 110 as successive layers of the object 102 are formed.

Although FIG. 1 illustrates a representative example of an additive manufacturing process, this is not intended to be limiting, and the embodiments described herein can be adapted to other types of additive manufacturing systems (e.g., vat-based systems) and/or other types of additive manufacturing processes (e.g., material jetting, binder jetting, material extrusion, powder bed fusion, sheet lamination, directed energy deposition).

Examples of additive manufacturing techniques that are applicable to the present technology include, but are not limited to, the following: (1) vat photopolymerization, in which an object is constructed from a vat or other bulk source of liquid photopolymer resin, including techniques such as stereolithography (SLA), digital light processing (DLP), continuous liquid interface production (CLIP), two-photon induced photopolymerization (TPIP), and volumetric additive manufacturing; (2) material jetting, in which material is jetted onto a build platform using either a continuous or drop on demand (DOD) approach; (3) binder jetting, in which alternating layers of a build material (e.g., a powder-based material) and a binding material (e.g., a liquid binder) are deposited by a print head; (4) material extrusion, in which material is drawn though a nozzle, heated, and deposited layer-by-layer, such as fused deposition modeling (FDM) and direct ink writing (DIW); (5) powder bed fusion, including techniques such as direct metal laser sintering (DMLS), electron beam melting (EBM), selective heat sintering (SHS), selective laser melting (SLM), and selective laser sintering (SLS); (6) sheet lamination, including techniques such as laminated object manufacturing (LOM) and ultrasonic additive manufacturing (UAM); and (7) directed energy deposition, including techniques such as laser engineering net shaping, directed light fabrication, direct metal deposition, and 3D laser cladding. Optionally, an additive manufacturing process can use a combination of two or more additive manufacturing techniques.

For example, the additively manufactured object can be fabricated using a vat photopolymerization process in which light is used to selectively cure a vat or other bulk source of a curable material (e.g., a polymeric resin). Each layer of curable material can be selectively exposed to light in a single exposure (e.g., DLP) or by scanning a beam of light across the layer (e.g., SLA). Vat polymerization can be performed in a “top-down” or “bottom-up” approach, depending on the relative locations of the material source, light source, and build platform.

As another example, the additively manufactured object can be fabricated using high temperature lithography (also known as “hot lithography”). High temperature lithography can include any photopolymerization process that involves heating a photopolymerizable material (e.g., a polymeric resin). For example, high temperature lithography can involve heating the material to a temperature of at least 30° C., 40° C., 50° C., 60° C., 70° C., 80° C., 90° C., 100° C., 110° C., or 120° C. In some embodiments, the material is heated to a temperature within a range from 50° C. to 120° C., from 90° C. to 120° C., from 100° C. to 120° C., from 105° C. to 115° C., or from 105° C. to 110° C. The heating can lower the viscosity of the photopolymerizable material before and/or during curing, and/or increase reactivity of the photopolymerizable material. Accordingly, high temperature lithography can be used to fabricate objects from highly viscous and/or poorly flowable materials, which, when cured, may exhibit improved mechanical properties (e.g., stiffness, strength, stability) compared to other types of materials. For example, high temperature lithography can be used to fabricate objects from a material having a viscosity of at least 5 Pa-s, 10 Pa-s, 15 Pa-s, 20 Pa-s, 30 Pa-s, 40 Pa-s, or 50 Pa-s at 20° C. Representative examples of high-temperature lithography processes that may be incorporated in the methods herein are described in International Publication Nos. WO 2015/075094, WO 2016/078838, WO 2018/032022, WO 2020/070639, WO 2021/130657, and WO 2021/130661, the disclosures of each of which are incorporated herein by reference in their entirety.

In some embodiments, the additively manufactured object is fabricated using continuous liquid interphase production (also known as “continuous liquid interphase printing”) in which the object is continuously built up from a reservoir of photopolymerizable resin by forming a gradient of partially cured resin between the building surface of the object and a polymerization-inhibited “dead zone.” In some embodiments, a semi-permeable membrane is used to control transport of a photopolymerization inhibitor (e.g., oxygen) into the dead zone in order to form the polymerization gradient. Representative examples of continuous liquid interphase production processes that may be incorporated in the methods herein are described in U.S. Patent Publication Nos. 2015/0097315, 2015/0097316, and 2015/0102532, the disclosures of each of which are incorporated herein by reference in their entirety.

As another example, a continuous additive manufacturing method can achieve continuous build-up of an object geometry by continuous movement of the build platform (e.g., along the vertical or Z-direction) during the irradiation phase, such that the hardening depth of the irradiated photopolymer is controlled by the movement speed. Accordingly, continuous polymerization of material on the build surface can be achieved. Such methods are described in U.S. Pat. No. 7,892,474, the disclosure of which is incorporated herein by reference in its entirety. In another example, a continuous additive manufacturing method can involve extruding a composite material composed of a curable liquid material surrounding a solid strand. The composite material can be extruded along a continuous three-dimensional path in order to form the object. Such methods are described in U.S. Pat. No. 10,162,224 and U.S. Patent Publication No. 2014/0061974, the disclosure of which is incorporated herein by reference in its entirety. In yet another example, a continuous additive manufacturing method can utilize a “heliolithography” approach in which the liquid photopolymer is cured with focused radiation while the build platform is continuously rotated and raised. Accordingly, the object geometry can be continuously built up along a spiral build path. Such methods are described in U.S. Pat. No. 10,162,264 and U.S. Patent Publication No. 2014/0265034, the disclosures of which are incorporated herein by reference in their entirety.

In a further example, the additively manufactured object can be fabricated using a volumetric additive manufacturing (VAM) process in which an entire object is produced from a 3D volume of resin in a single print step, without requiring layer-by-layer build up. During a VAM process, the entire build volume is irradiated with energy, but the projection patterns are configured such that only certain voxels will accumulate a sufficient energy dosage to be cured. Representative examples of VAM processes that may be incorporated into the present technology include tomographic volumetric printing, holographic volumetric printing, multiphoton volumetric printing, and xolography. For instance, a tomographic VAM process can be performed by projecting 2D optical patterns into a rotating volume of photosensitive material at perpendicular and/or angular incidences to produce a cured 3D structure. A holographic VAM process can be performed by projecting holographic light patterns into a stationary reservoir of photosensitive material. A xolography process can use photoswitchable photoinitiators to induce local polymerization inside a volume of photosensitive material upon linear excitation by intersecting light beams of different wavelengths. Additional details of VAM processes suitable for use with the present technology are described in U.S. Pat. No. 11,370,173, U.S. Patent Publication No. 2021/0146619, U.S. Patent Publication No. 2022/0227051, International Publication No. WO 2017/115076, International Publication No. WO 2020/245456, International Publication No. WO 2022/011456, and U.S. Provisional Ser. No. 63/181,645, the disclosures of each of which are incorporated herein by reference in their entirety.

In yet another example, the additively manufactured object can be fabricated using a powder bed fusion process (e.g., selective laser sintering) involving using a laser beam to selectively fuse a layer of powdered material according to a desired cross-sectional shape in order to build up the object geometry. As another example, the additively manufactured object can be fabricated using a material extrusion process (e.g., fused deposition modeling) involving selectively depositing a thin filament of material (e.g., thermoplastic polymer) in a layer-by-layer manner in order to form an object. In yet another example, the additively manufactured object can be fabricated using a material jetting process involving jetting or extruding one or more materials onto a build surface in order to form successive layers of the object geometry.

The additively manufactured object can be made of any suitable material or combination of materials. As discussed above, in some embodiments, the additively manufactured object is made partially or entirely out of a polymeric material, such as a curable polymeric resin. The resin can be composed of one or more monomer components that are initially in a liquid state. The resin can be in the liquid state at room temperature (e.g., 20° C.) or at an elevated temperature (e.g., a temperature within a range from 50° C. to 120° C.). When exposed to energy (e.g., light), the monomer components can undergo a polymerization reaction such that the resin solidifies into the desired object geometry. Representative examples of curable polymeric resins and other materials suitable for use with the additive manufacturing techniques herein are described in International Publication Nos. WO 2019/006409, WO 2020/070639, and WO 2021/087061, the disclosures of each of which are incorporated herein by reference in their entirety.

Optionally, the additively manufactured object can be fabricated from a plurality of different materials (e.g., at least two, three, four, five, or more different materials). The materials can differ from each other with respect to composition, curing conditions (e.g., curing energy wavelength), material properties before curing (e.g., viscosity), material properties after curing (e.g., stiffness, strength, transparency), and so on. In some embodiments, the additively manufactured object is formed from multiple materials in a single manufacturing step. For instance, a multi-tip extrusion apparatus can be used to selectively dispense multiple types of materials from distinct material supply sources in order to fabricate an object from a plurality of different materials. Examples of such methods are described in U.S. Pat. Nos. 6,749,414 and 11,318,667, the disclosures of which are incorporated herein by reference in their entirety. Alternatively or in combination, the additively manufactured object can be formed from multiple materials in a plurality of sequential manufacturing steps. For instance, a first portion of the object can be formed from a first material in accordance with any of the fabrication methods herein, then a second portion of the object can be formed from a second material in accordance with any of the fabrication methods herein, and so on, until the entirety of the object has been formed.

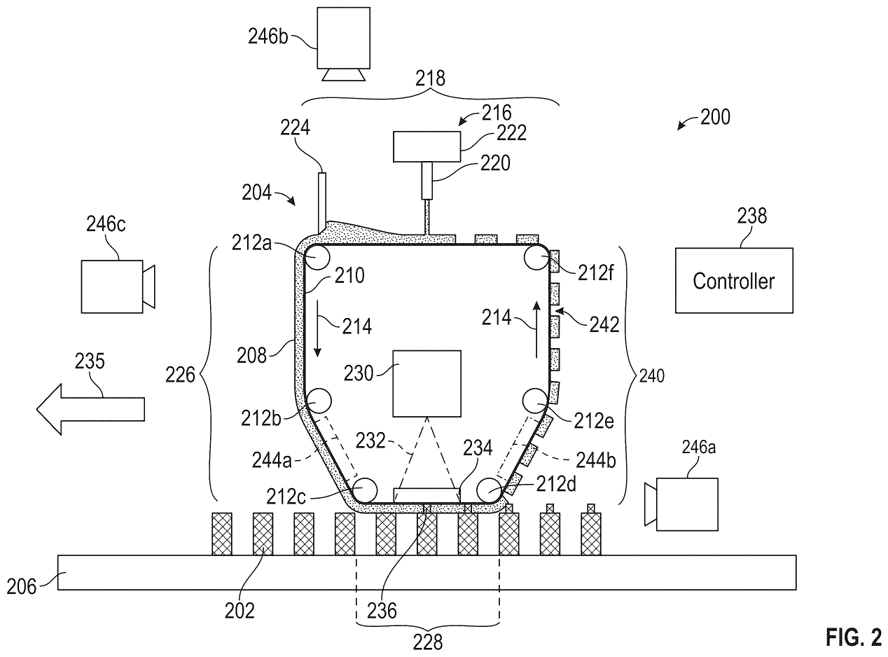

FIG. 2 is a partially schematic side view of a system 200 for additive manufacturing configured in accordance with embodiments of the present technology. The system 200 is configured to fabricate one or more objects 202 using an additive manufacturing process. In some embodiments, the system 200 is configured to monitor the additive manufacturing process and implement corrections as appropriate to ensure that the objects 202 are fabricated accurately, since deviations between the intended and actual geometry of an object 202 may compromise the function and properties of the object 202. For example, certain types of dental appliances may have small and/or detailed features with strict manufacturing tolerances. Regions of the dental appliance that are important or necessary for certain functions (e.g., clinical efficacy, proper positioning, ergonomics, mechanical properties, aesthetics) may also be subject to strict tolerances. For example, the tolerance for certain features and/or regions of a dental appliance can be less than or equal to 500 μm, 200 μm, 100 μm, 50 μm, 20 μm, or 10 μm. If the actual size, shape, and/or location of the features and/or regions deviate significantly from the intended size, shape, and/or location (e.g., the deviation exceeds the tolerance), the appliance may be unsuitable for its intended function, e.g., the appliance may not fit properly on the teeth and/or may fail to apply the correct forces to the teeth.

The system 200 includes a printer assembly 204 that forms one or more objects 202 on a build platform 206 (e.g., a tray, plate, film, sheet, printer bed, or other planar or non-planar substrate) by applying energy to a curable material 208 (e.g., a photopolymerizable resin). In the illustrated embodiment, the printer assembly 204 includes a carrier film 210 configured to deliver the curable material 208 to the build platform 206. The carrier film 210 can be a flexible loop of material having an outer surface and an inner surface. The outer surface of the carrier film 210 can adhere to and carry a thin layer of the curable material 208. The inner surface of the carrier film 210 can contact a drive mechanism for moving the carrier film 210, such as one or more rollers 212a-212f that rotate to move the carrier film 210 in a continuous loop trajectory, e.g., along the directions indicated by arrows 214. The rollers 212a-212f can include any suitable geometry for facilitating the movement of the carrier film 210. For instance, the rollers 212a-212f can include cylinders, spools, blades, etc.

The printer assembly 204 can also include a material source 216 configured to apply the curable material 208 to the carrier film 210 at a deposition zone 218 (also known as a “coating zone” or “recoating zone”). In the illustrated embodiment, the material source 216 is located at the upper portion of the printer assembly 204, and the deposition zone 218 is an upper horizontal segment of the carrier film 210 between rollers 212a and 212f. In other embodiments, however, the material source 216 and/or deposition zone 218 can be at different locations in the printer assembly 204. The material source 216 can include nozzles, ports, reservoirs, etc., that deposit the curable material 208 onto the outer surface of the carrier film 210. In some embodiments, for instance, the material source 216 includes a nozzle 220 coupled to a reservoir 222. The system 200 can also include one or more blades 224 (e.g., doctor blades, recoater blades) that smooth the deposited curable material 208 into a relatively thin, uniform layer. For example, the curable material 208 can be formed into a layer having a thickness within a range from 100 microns to 500 microns, 200 microns to 300 microns, or any other desired thickness.

The curable material 208 can be conveyed by the carrier film 210 toward the build platform 206. In some embodiments, the curable material 208 is transported through a pre-print zone 226 downstream of the deposition zone 218. The pre-print zone 226 can include a vertical segment, an angled segment, or a combination thereof of the carrier film 210. For instance, although the pre-print zone 226 is illustrated as including a vertical segment of the carrier film 210 between the rollers 212a and 212b and an angled segment of the carrier film 210 between the rollers 212b and 212c, in other embodiments, the pre-print zone 226 can include only a vertical segment or only an angled segment.

The build platform 206 can be located proximate to a print zone 228 of the carrier film 210 (also known as an “exposure zone”). In the illustrated embodiment, the build platform 206 is located below the printer assembly 204, and the print zone 228 is a lower horizontal segment of the carrier film 210 between rollers 212c and 212d. In other embodiments, however, the build platform 206 and/or print zone 228 can be positioned at different locations in the printer assembly 204. The distance between the carrier film 210 and build platform 206 can be adjustable so that the curable material 208 at the print zone 228 can be brought into direct contact with the surface of the build platform 206 (when printing the initial layer of the object 202) or with the surface of the object 202 (when printing subsequent layers of the object 202). For example, the build platform 206 can include or be coupled to an actuator (e.g., a motor—not shown) that raises and/or lowers the build platform 206 to the desired height during the manufacturing process. Alternatively or in combination, the printer assembly 204 can include or be coupled to a motor (not shown) that raises and/or lowers the printer assembly 204 relative to the build platform 206.

The printer assembly 204 can include an energy source 230 (e.g., a projector, light engine, laser scanner) that outputs energy 232 (e.g., light, such as UV light) having a wavelength configured to partially or fully cure the curable material 208. The carrier film 210 can be partially or completely transparent to the wavelength of the energy 232 to allow the energy 232 to pass through the carrier film 210 and onto the portion of the curable material 208 above the build platform 206. Optionally, a transparent plate 234 can be disposed between the energy source 230 and the carrier film 210 to guide the carrier film 210 into a specific position (e.g., height) relative to the build platform 206.

During operation, the energy 232 can be patterned or scanned in a suitable pattern onto the curable material 208, thus forming a layer of cured material 236 onto the build platform 206 and/or on a previously formed portion of the object 202. The geometry of the cured material 236 can correspond to the desired cross-sectional geometry for the object 202. The parameters for operating the energy source 230 (e.g., exposure time, exposure pattern, exposure wavelength, energy density, power density) can be set based on instructions from a controller 238, as described in further detail below.

In some embodiments, the energy 232 is applied to the curable material 208 while the carrier film 210 moves to circulate the curable material 208 through the print zone 228. To maintain zero or substantially zero relative velocity between the curable material 208 and the build platform 206, the printer assembly 204 can concurrently move horizontally relative to the build platform 206 opposite the direction of the motion of the carrier film 210 at the print zone 228, e.g., as indicated by arrow 237. The motion of the printer assembly 204 can also increase the printable surface area of the build platform 206. The energy 232 output by the energy source 230 can be coordinated with the movement of the carrier film 210 and build platform 206 so that the layer of cured material 236 is formed with the correct geometry. For example, the energy source 230 can be a scrolling light engine (e.g., a scrolling DLP) or laser scanner that outputs the energy 232 in a pattern that varies over time to match the motion of the printer assembly 204 and carrier film 210. In other embodiments, however, the printer assembly 204 can be a stationary device that does not move relative to the build platform 206 while the energy 232 is being applied to the curable material 208.

After curing, the newly formed layer of cured material 236 can be separated from the carrier film 210 and the remaining curable material 208 at the print zone 228 (also referred to herein as “peel-off”). In some embodiments, the separation occurs at least in part due to peel forces produced by the carrier film 210 wrapping around the roller 212d immediately downstream of the print zone 228. The remaining curable material 208 can be conveyed by the carrier film 210 away from the build platform 206, and into a post-print zone 240 downstream of the print zone 228 (also known as a “peel-off zone”). As described elsewhere herein, the remaining curable material 208 can include recesses 242 (also known as “imprints”) left by separation of the cured material 236 from the carrier film 210. The post-print zone 240 can include a vertical segment, an angled segment, or a combination thereof of the carrier film 210. For instance, although the post-print zone 240 is illustrated as having an angled segment of the carrier film 210 between the rollers 212d and 212e and a vertical segment of the carrier film 210 between the rollers 212e and 212f, in other embodiments, the system 200 can include only a vertical segment or only an angled segment. The presence of an angled segment of carrier film 210 immediately downstream of the print zone 228 can adjust the peel angle produced by the roller 212d, and thus, the peel force applied to the cured material 236, to enhance separation from the surrounding curable material 208.

The remaining curable material 208 conveyed away from the build platform 206 can be circulated by the carrier film 210 back toward the deposition zone 218. At the deposition zone 218, the material source 216 can apply additional curable material 208 onto the carrier film 210 and/or smooth the curable material 208 to fill in the recesses 242 and re-form a uniform layer of curable material 208 on the carrier film 210. The curable material 208 can then be recirculated back through the pre-print zone 226, and then to the print zone 228 and build platform 206 to fabricate subsequent layers of the objects 202. This process can be repeated to iteratively build up individual object layers on the build platform 206 until the objects 202 are complete. The objects 202 and build platform 206 can then be removed from the system 200 for post-processing.

Optionally, the printer assembly 204 can be configured to produce the objects 202 via a high temperature lithography process utilizing a highly viscous resin. In such embodiments, the printer assembly 204 can include one or more heat sources (e.g., heating plates, infrared lamps) for heating the curable material 208 to lower the viscosity to a range suitable for additive manufacturing. The heat sources can be positioned near or in direct contact with the carrier film 210 to heat the curable material 208 supported by the carrier film 210. For example, the printer assembly 204 can include a first heat source 244a positioned against the segment of the carrier film 210 before the build platform 206, and a second heat source 244b positioned against the segment of the carrier film 210 after the build platform 206. In some embodiments, the heat sources can additionally or alternatively be located at any suitable portion of the printer assembly 204, such as on or within the build platform 206, on or within the material source 216, at the deposition zone 218, on or within the coating blades 224, at the pre-print zone 226, at the print zone 228, at the post-print zone 240, or combinations thereof.

The controller 238 (shown schematically) is operably coupled to the printer assembly 204 (e.g., to the build platform 206, rollers 212a-212f, material source 216, and/or energy source 230) to control the operations thereof. The controller 238 can be or include a computing device including one or more processors and memory storing instructions for performing the additive manufacturing, monitoring, and correction processes described herein. For example, the controller 238 can receive a digital representation of the objects 202 to be fabricated and can transmit instructions to the energy source 230 to apply energy 232 to the curable material 208 to form the object cross-sections. As previously discussed, the controller 238 can control various operational parameters of the energy source 230, such as the exposure time, exposure pattern, exposure wavelength, energy density, power density, and/or other parameters affecting the printing process. Optionally, the controller 238 can also determine and control other operational parameters, such as the positioning of the printer assembly 204 (e.g., vertical and/or horizontal position) relative to the build platform 206, the movement speed and/or direction of the carrier film 210, the tension in the carrier film 210, the rotational speed and/or direction of the rollers 212a-212f, the amount of curable material 208 deposited by the material source 216, and/or the thickness of the curable material 208 on the carrier film 210.

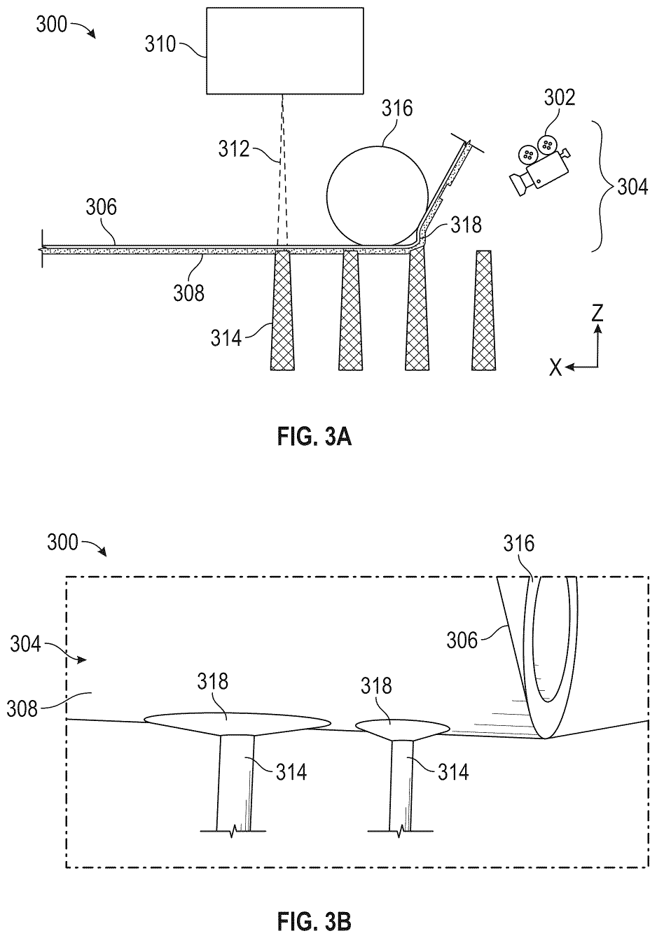

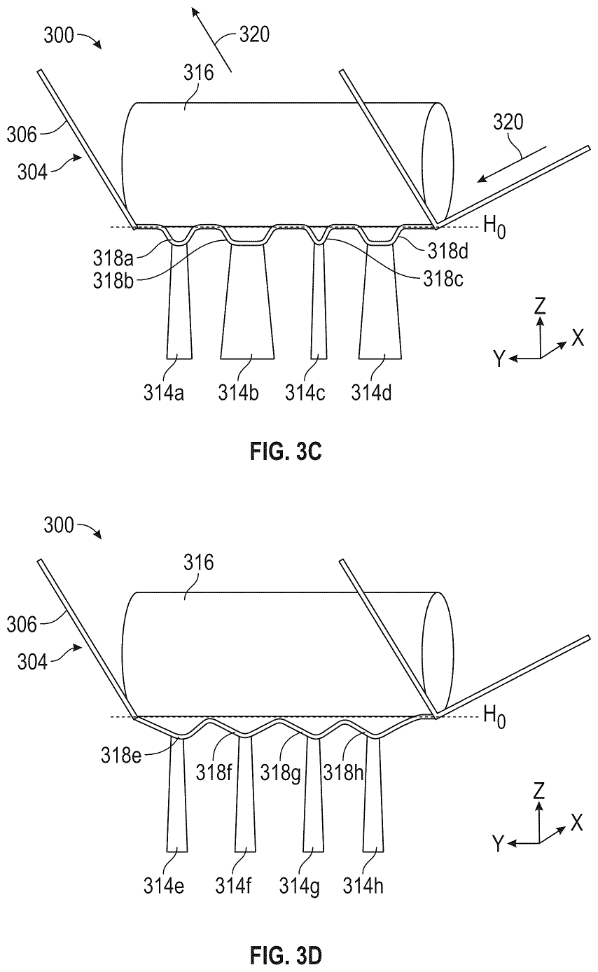

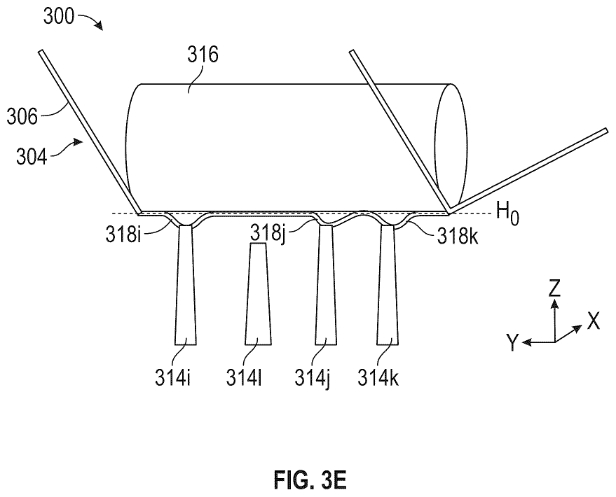

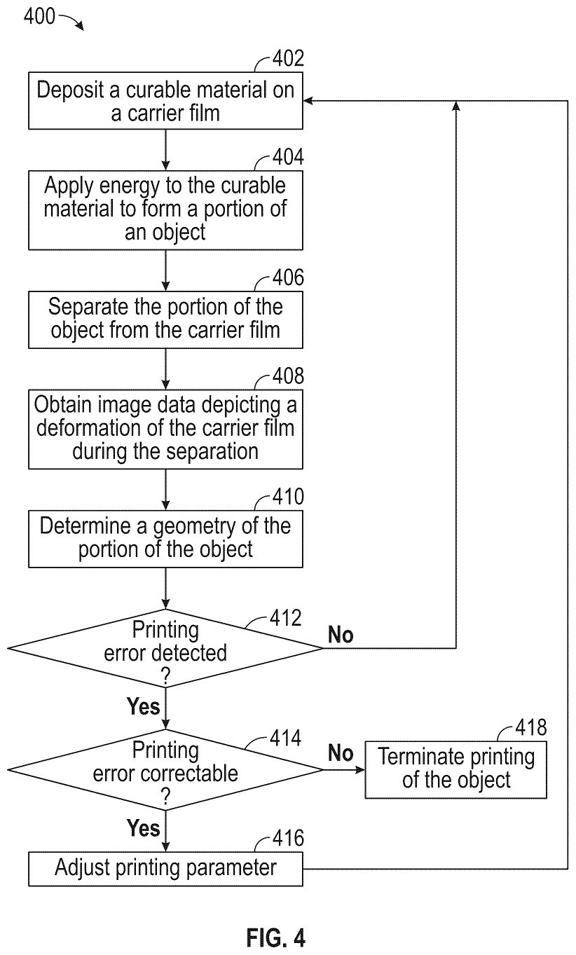

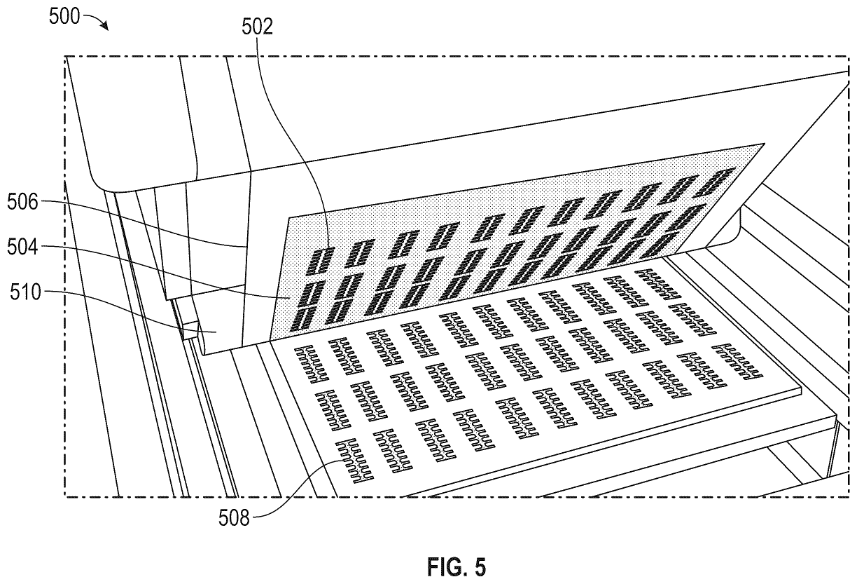

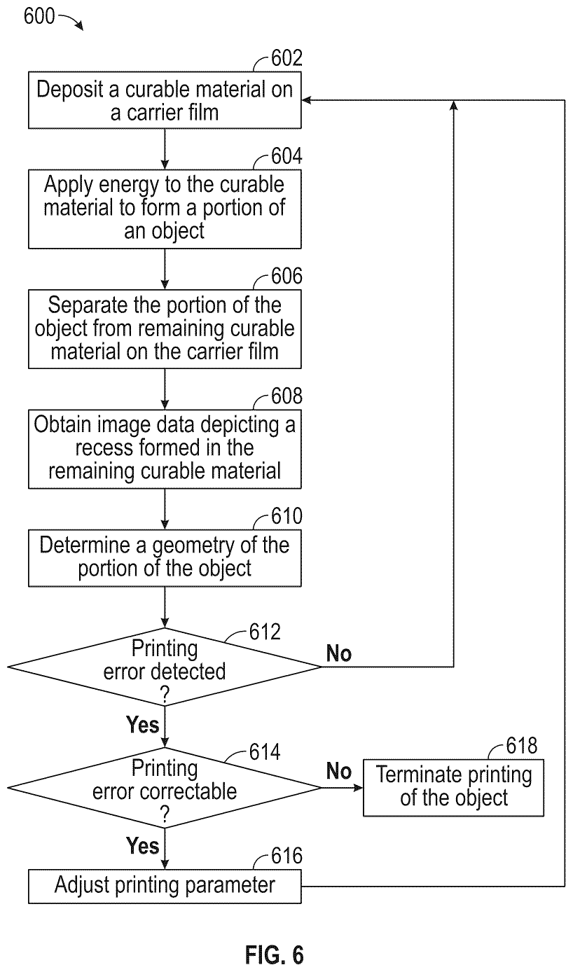

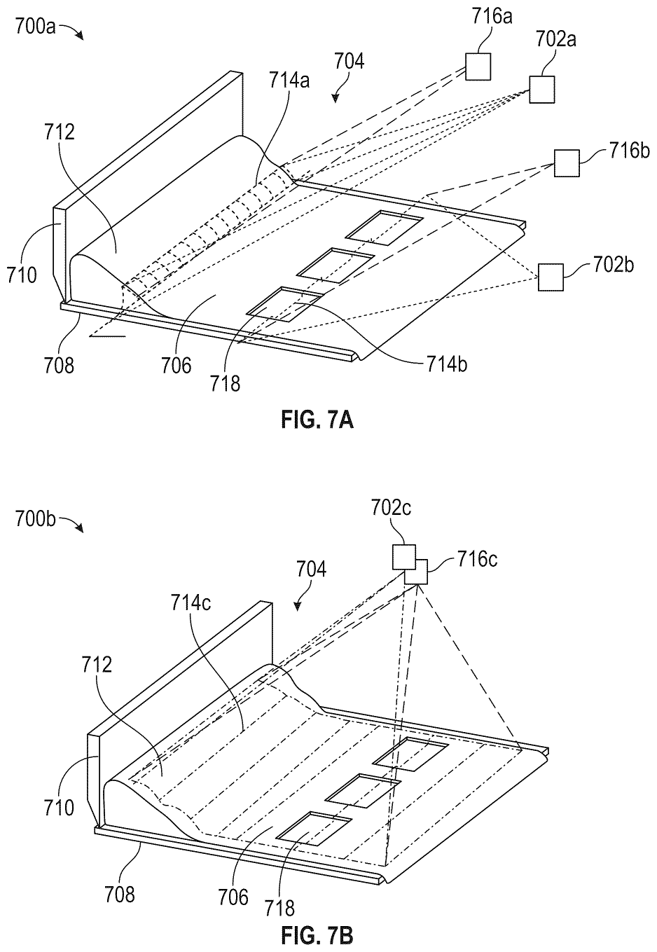

In some embodiments, the system 200 is configured to monitor various locations of the printer assembly 204 to detect whether any printing errors have occurred. The monitoring can be performed using one or more imaging devices 246a-246c (collectively, “imaging devices 246”). For example, the system 200 can include a first imaging device 246a positioned at or near the post-print zone 240 of the carrier film 210. The first imaging device 246a can obtain image data of the carrier film 210 during the peel-off process (e.g., as described below in connection with FIGS. 3A-4) and/or can obtain image data of the recesses 242 in the curable material 208 (e.g., as described below in connection with FIGS. 5 and 6). Optionally, the system 200 can include a second imaging device 246b positioned at or near the deposition zone 218 and/or a third imaging device 246c positioned at or near the pre-print zone 226 to obtain image data of the curable material 208 during or after deposition onto the carrier film 210 (e.g., as described below in connection with FIGS. 7A-7D). The second imaging device 246b and/or the third imaging device 246c can be used to monitor the deposition of the curable material 208 on the carrier film 210, such as the fill level, presence of irregularities (e.g., debris, bubbles, streaks), viscosity variations (e.g., based on the height, length, and/or shape of the curable material 208 in the deposition zone 218), etc.

Although FIG. 2 illustrates three imaging devices 246, the system 200 can include any suitable number of imaging devices 246, such as one, two, four, five, or more imaging devices 246. Each imaging device 246 may be independently positioned at any suitable location relative to the printer assembly 204, such as at or near the deposition zone 218, at or near the pre-print zone 226, at or near the print zone 228, and/or at or near the post-print zone 240. For instance, monitoring of the print zone 228 can be performed using a transparent or translucent build platform 206 and by placing an imaging device 246 under the build platform 206 to observe the curing and/or peel-off processes from below.

Although the imaging devices 246 are illustrated as being positioned on the outside of the carrier film 210 (closer to the side with the curable material 208), in other embodiments, some all of the imaging devices 246 can instead be positioned on the inside of the carrier film 210 (closer to the side without the curable material 208). For instance, monitoring of the print zone 228 may be performed from above, e.g., using an imaging device 246 located proximate to the energy source 230.

In some embodiments, fiducials (e.g., markers, patterns) are located on the printer assembly 204 within the field of view of the imaging device 246, and the locations of the fiducials in the image data generated by the imaging device 246 can be analyzed to confirm whether the imaging device 246 is placed correctly. Moreover, image processing techniques such as digital distortion correction can be applied to the image data, e.g., to allow for monitoring from different and/or non-ideal angles that may be susceptible to distortions and/or other imaging artifacts.

Some or all of the imaging devices 246 may be coupled to the printer assembly 204 (e.g., as part of a “backpack” mounted to the printer assembly 204) and thus may move along with the printer assembly 204. Some or all of the imaging devices 246 may be separate from the printer assembly 204 (e.g., coupled to a housing surrounding the printer assembly 204) and thus may remain stationary as the printer assembly 204 moves. Some or all of the imaging devices 246 may be in a fixed position and/or orientation with respect to the component to which they are mounted. Some or all of the imaging devices 246 may be movable with respect to the component to which they are mounted (e.g., with one, two, or three degrees of freedom in translation and/or one, two, or three degrees of freedom in rotation).

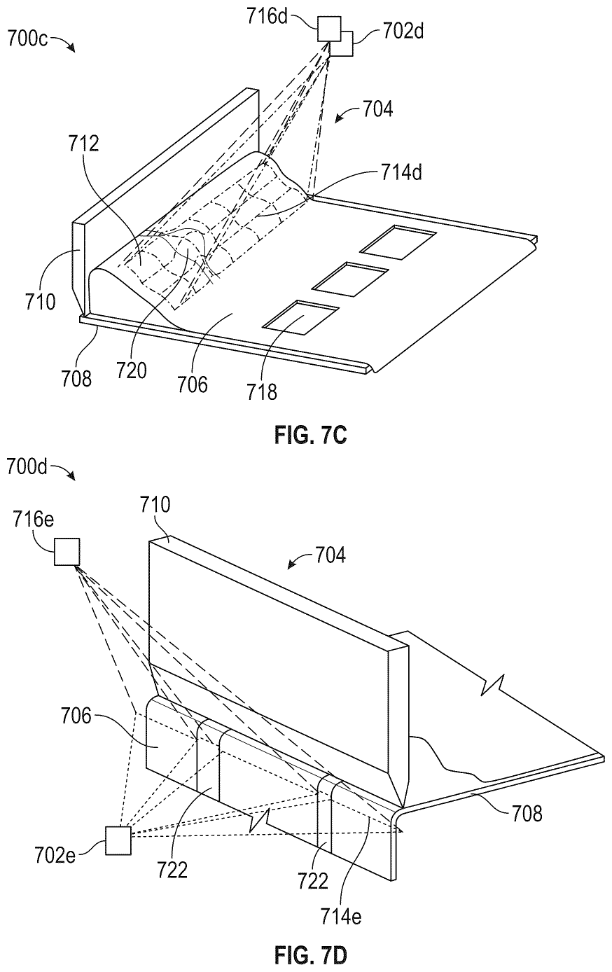

The imaging devices 246 can be cameras, scanners, or any other device capable of obtaining image data of a respective portion of the printer assembly 204. The image data can include photographs and/or videos, and can be obtained at any suitable wavelength (e.g., visible, infrared, ultraviolet). For instance, the imaging wavelength can be selected to enhance visibility of the curable material 208 and/or to enhance visual differences between the curable material 208 before and after curing, e.g., infrared wavelengths may provide improved visibility in some embodiments. As another example, the imaging wavelength can be selected to avoid inadvertent curing of the curable material 208 (e.g., the imaging wavelength can be different from the energy wavelength that cures the curable material 208). In a further example, infrared wavelengths may be used to monitor the temperature distribution within the curable material 208 and/or over larger areas of the printer assembly 204 (e.g., the build platform 206, deposition zone 218, pre-print zone 226, print zone 228). Optionally, some or all of the imaging devices 246 may be used with accessories such as light sources, filters, etc., to facilitate imaging at different wavelengths. For example, an infrared light source can be used to provide illumination in an infrared wavelength, and the imaging devices 246 can be used with an infrared bandpass filter for obtaining data at the infrared wavelength. Moreover, some or all of the imaging devices 246 may be used in combination with a projector (not shown) that projects a pattern onto the respective portion of the printer assembly 204 to facilitate visualization of the curable material 208 (e.g., as described below in connection with FIGS. 7A-8).

The imaging devices 246 can be operably coupled to the controller 238 via wired and/or wireless connections to transmit image data thereto. The controller 238 can analyze the image data produced by the imaging devices 246 to detect whether printing errors have occurred. For instance, the controller 238 can use the image data to detect whether there are any errors in the geometry of the printed objects 202, e.g., if the actual geometry of an object 202 deviates significantly from the target geometry for the object 202. As another example, the controller 238 can use the image data to detect whether the layer delamination has occurred, e.g., the cured material 236 has separated from the object 202 and thus is present in the post-print zone 240. In a further example, the controller 238 can use the image data to detect whether there are any streaks, debris, bubbles, etc., present in the curable material 208. As yet another example, the controller 238 can use the image data to detect whether the thickness of the curable material 208 is within a predetermined range. As a further example, the controller 238 can use the image data to detect whether there are other issues with the additive manufacturing process, such as are missing and/or defective objects 202, missing and/or misaligned segments of the build platform 206, incorrect carrier film 210 speed and/or position, etc.

If the controller 238 detects a printing error, the controller 238 can adjust one or more printing parameters of the system 200 to correct the printing error and/or to avoid propagation of the printing error to unaffected objects 202.The adjustments can include adjustments to any of the following: a pattern of the energy 232, an energy dosage of the energy 232, an exposure time of the energy 232, a layer thickness of the curable material 208, a temperature of the curable material 208, a speed of the carrier film 210, and/or a tension of the carrier film 210. The controller 238 can adjust one parameter at a time, or can adjust multiple parameters concurrently. In some embodiments, the adjustments are applied to the entire portion of the object 202 to be printed, e.g., the controller 238 increases the exposure time and/or power density uniformly across the whole portion. In other embodiments, however, the adjustments can be selectively applied only to those portions of the object 202 that exhibited printing errors and/or are determined to be more susceptible to printing errors.

The controller 238 can determine the appropriate adjustments to be made in various ways. For example, the controller 238 can adjust one or more parameters according to preset instructions (e.g., stored in lookup tables, databases, or other suitable data structures). In some embodiments, the controller 238 increases or decreases a parameter by a predetermined increment until the printing error is resolved. Optionally, the controller 238 can adjust a parameter by a variable increment based on the severity of the detected error (e.g., a larger adjustment is used if more extensive error is detected), the number of previous attempts to resolve the error (e.g., a larger adjustment is used if previous adjustments failed to correct the issue), and/or other suitable factors. Alternatively or in combination, the controller 238 can determine the adjustment using a machine learning algorithm that is configured to identify the adjustment that is likely to resolve a particular defect. In such embodiments, the machine learning algorithm can be trained on data obtained from previous printing processes. Once the controller 238 has determined which adjustment(s) should be made, the controller 238 can transmit signals to the appropriate component(s) of the system 200 (e.g., the energy source 230, material source 216, rollers 212a-212f, heat sources 244a, 244b) via wired and/or wireless connections to effectuate the desired adjustments. For example, the controller 238 can send instructions to the energy source 230 to modify the exposure time, power and/or energy density, etc., of the applied energy 232; can send instructions to the material source 216 to modify the layer height of the cured material 236; can send instructions to the rollers 212a-212f to modify the speed and/or tension of the carrier film 210, etc.

In some embodiments, if the printing error involves an error in the geometry of a portion (e.g., layer) of an object 202, the controller 238 can correct the error by reprinting the affected portion of the object 202 and/or by adjusting the printing parameters for the next portion (e.g., next layer) of the object 202. Optionally, if the error is determined to be too severe to correct, the controller 238 can terminate printing of the affected object 202 while continuing printing of other objects 202 in the batch, e.g., by masking out or otherwise removing the affected object 202 from the print instructions for the batch. This approach can prevent the error in the affected object 202 from propagating to other objects 202 in the batch, while also avoiding waste of time and resources that would occur if the entire batch were terminated.

The controller 238 can then monitor the outcome of the print cycle via the imaging devices 246. If the printing error was successfully resolved, the controller 238 can instruct the printer assembly 204 to continue fabricating the rest of the objects 202 using the adjusted parameters. If the printing error was not resolved, the controller 238 can make further adjustments to the printing parameters. The monitoring and adjustment process can be repeated throughout the additive manufacturing process until the objects 202 are completed. Optionally, if the controller 238 determines that the printing errors are sufficiently severe and/or is unable to resolve the printing errors via automated adjustments, the controller 238 can output an alert notifying an operator that manual intervention is needed.

In some embodiments, the controller 238 records the history of the entire additive manufacturing process, including the print outcome for each object 202, such as whether any printing errors occurred while forming the objects 202 and any adjustments that were made to correct the errors (such as termination of the printing of an affected object 202). This information can be used to provide feedback for future additive manufacturing processes, e.g., whether certain object designs and/or printing parameters consistently resulted in printing errors, whether certain adjustments are more likely to successfully mitigate errors than other adjustments, etc. Additionally, this information can be used for tracing purposes in case there are any issues with downstream processing and/or use of the objects 202.

The configuration of the system 200 can be modified in many ways. For instance, other types of sensors besides the imaging devices 246 may be used to monitor the printer assembly 204, such as force sensors, strain sensors, distance sensors (e.g., ultrasonic sensors, time-of-flight sensors, rangefinders), position sensors, angle sensors, optical sensors (e.g., refractometers, spectrophotometers), temperature sensors, viscosity sensors, or combinations thereof. Additional examples of sensors that may be used are described in U.S. patent application Ser. No. 18/173,585, the disclosure of which is incorporated by reference herein in its entirety.

FIGS. 3A-7 illustrate representative examples of methods and devices that may be used in the additive manufacturing systems and processes described herein. Any of the features of the embodiments of FIGS. 3A-7 may be incorporated into the system 200 of FIG. 2 and/or combined with each other.

FIGS. 3A-3E illustrate monitoring of an additive manufacturing process via imaging of carrier film deformation at a post-print zone, in accordance with embodiments of the present technology. Specifically, FIG. 3A is a partially schematic side view of a printer assembly 300 including an imaging device 302 near a post-print zone 304, FIG. 3B is a perspective view of the post-print zone 304 of the printer assembly 300, and FIGS. 3C-3E illustrate deformation of a carrier film 306 that may occur at the post-print zone 304.

Referring first to FIG. 3A, the printer assembly 300 can be identical or generally similar to the printer assembly 204 of FIG. 2. For instance, the printer assembly 300 can include a carrier film 306 that supports a layer of a curable material 308. The carrier film 306 can convey the curable material 308 to an energy source 310 that outputs energy 312 to cure the curable material 308, thereby forming a portion (e.g., layer) of an object 314.

Referring next to FIGS. 3A and 3B together, the carrier film 306 can be coupled to a drive mechanism (e.g., one or more rollers 316) that circulates the carrier film 306 and the curable material 308 to the post-print zone 304. As shown in FIG. 3A, the carrier film 306 can wrap around a roller 316 that is downstream of the energy source 310, thereby transitioning from a horizontal orientation to an angled orientation. This transition can produce peel-off forces that separate the newly cured portion of the object 314 from the remaining curable material 308 on the carrier film 306. The cured object portion may exhibit some adhesion to the material of the carrier film 306, such that the carrier film 306 is deformed during the separation process. For instance, certain regions 318 of the carrier film 306 may be pulled away from the roller 316 together with the cured object portion, while the remaining regions of the carrier film 306 may remain substantially flush with the roller 316.

Referring again to FIG. 3A, one or more imaging devices 302 may be located proximate to the post-print zone 304 to obtain image data depicting the deformation of the carrier film 306 during the peel-off process. For instance, an imaging device 302 may be positioned and oriented so that the field of view of the imaging device 302 includes the portion of the carrier film 306 at which peel-off occurs (e.g., the portion adjacent or near the roller 316). Accordingly, the image data produced by the imaging device 302 can show the deformation of the carrier film 306 and/or the stick-and-separate dynamics of the cured portion of the object 314. These mechanical interactions between the cured object portion and the carrier film 306 can be indicative of the geometry of the object portion.

In some embodiments, the deformation of the carrier film 306 includes a change in a height profile of the carrier film 306. For example, the adhesion between the carrier film 306 and the cured object portions can result in the carrier film 306 being pulled away from the surface of the roller 316 at the locations of the objects 314, thereby resulting in variations in the height of the carrier film 306. The height profile can be determined from the image data produced by the imaging device 302 and can be correlated to the geometry (e.g., size, shape, location) of the corresponding cured object portions.

For example, referring to FIG. 3C, the carrier film 306 has four deformed regions 318a-318d corresponding to four respective objects 314a-314d. The heights of the deformed regions 318a-318d (e.g., in the Z-direction) may be measured with respect to a baseline height H₀ of the carrier film 306, which may be the height of the carrier film 306 when in contact with the roller 316. The location of the deformed regions 318a-318d may correlate to the locations of the corresponding objects 314a-314d (e.g., along the Y-direction), and the widths of the deformed regions 318a-318d may correlate to the widths of the newly cured portions of the corresponding objects 314a-314d (e.g., as measured in the Y-direction). For instance, the last layer of object 314b is wider than the last layer of object 314a, and thus deformed region 318b is wider than deformed region 318a. Moreover, changes in the location and width of the deformed regions 318a-318d over time as the carrier film 306 moves (e.g., along the direction indicated by arrows 320) can be used to infer the overall size and shape of the corresponding objects 314a-314d (e.g., in both X-and Y-directions). Accordingly, image data of the carrier film 306 showing the locations and geometries of the deformed regions 318a-318d can be used to determine the locations and geometries of the corresponding objects 314a-314d.

Referring next to FIG. 3D, in the illustrated example, the carrier film 306 includes four deformed regions 318e-318h corresponding to four respective objects 314e-314h. The widths of the deformed regions 318e-318h are substantially equal, thus indicating that the widths of the last layers of the objects 314e-314h are also substantially equal.

Referring next to FIG. 3E, in the illustrated example, the carrier film 306 includes three deformed regions 318i-318k corresponding to three respective objects 314i-314k. However, there is no deformed region for the fourth object 314l, thus indicating that the last layer of the object 314l did not form properly and/or did not separate from the carrier film 306.

In some embodiments, computational approaches such as heuristic methods, finite element analysis, machine learning models, etc., can be used to determine the geometry of the object portions that caused the observed deformations in the carrier film 306. For instance, one or more machine learning models may be trained (e.g., using scans of successfully printed objects and corresponding images of film deformation during the printing of the objects) to predict the object geometry based on the observed deformation patterns. The machine learning model(s) can include, for example, convolutional neural networks (CNNs), recurrent neural networks (RNNs), generative adversarial networks (GANs), capsule networks (CapsNets), graph neural networks (GNNs), autoencoders, or vision transformers (ViTs). As another example, physics-based simulations (e.g., using finite element analysis) can be performed to determine the correlations between a printed object and the film deformation resulting from peel-off of the printed object.

FIG. 4 is a flow diagram illustrating a method 400 for monitoring and/or correcting additive manufacturing of an object, in accordance with embodiments of the present technology. The method 400 can be used to fabricate many different types of objects, such any of the dental appliances described herein. The method 400 can be performed using any of the systems and devices described herein, such as the system 200 of FIG. 2 and/or the printer assembly 300 of FIGS. 3A-3E. In some embodiments, some or all of the processes of the method 400 are implemented as computer-readable instructions (e.g., program code) that are configured to be executed by one or more processors of a computing device (e.g., a controller of an additive manufacturing system). The method 400 can be combined with any of the other methods described herein.

The method 400 can begin at block 402 with depositing a curable material on a carrier film. For example, the curable material can be a resin including one or more polymerizable components (e.g., monomers, oligomers, reactive polymers) and, optionally, one or more additives (e.g., catalysts, reaction inhibitors, blockers, viscosity modifiers, fillers, fibers, particles, binders, reactive diluents, solvents, pigments and/or dyes, stabilizers, surface-active compounds). In some embodiments, the curable material is a transparent or translucent material. The curable material can be deposited onto the carrier film using nozzles, blades, and/or other components that form the curable material into a thin, substantially uniform layer.

At block 404, the method 400 can include applying energy to the curable material to form a portion (e.g., layer) of an object. The energy can be light energy (e.g., ultraviolet light, visible light, infrared light), heat energy, or any type of energy that causes curing (e.g., polymerization) of the curable material. The energy can be applied to the curable material via an energy source (e.g., projector, light engine, laser) that produces an energy pattern corresponding to the target geometry for the object portion, thereby forming a layer of cured material at selected locations while the remaining curable material remains substantially uncured.

At block 406, the method 400 can continue with separating the portion of the object from the carrier film. As described elsewhere herein, the separation process can include peel-off of the cured material that forms the object portion from the carrier film and from remaining curable material on the carrier film. In some embodiments, the separation is effectuated by a drive mechanism that conveys the carrier film away from a build platform supporting the object. For instance, the drive mechanism can include one or more rollers that convey the carrier film past the build platform, and the separation may occur at least in part due to peel-off forces produced by the carrier film wrapping around a roller.

At block 408, the method 400 can include obtaining image data depicting a deformation of the carrier film during the separation. As described elsewhere herein, the cured object portion can exhibit some degree of adhesion to the carrier film, such that the carrier film is deformed (e.g., stretched and/or displaced) by the object portion during the separation process. The image data can include photographs and/or video produced by one or more imaging devices (e.g., cameras) positioned proximate to the carrier film to image the location where the separation occurs. In some embodiments, the image data includes a continuous stream of high-resolution images of the carrier film at or near the separation location (e.g., the post-print zone), thereby providing real-time or near-real-time monitoring of the deformation of the carrier film. Optionally, the image data can also depict a pattern projected onto the carrier film to facilitate visualization of the deformation, e.g., as discussed further below with respect to FIGS. 7A-8.

At block 410, the method 400 can continue with determining a geometry of the portion of the object, based on the image data. As described elsewhere herein, the location and amount of film deformation can correlate to the location and geometry of the object portion. For instance, the deformation may result in variations in the height of the carrier film, where regions of the carrier film with an increased height correspond to locations of object portions, and regions with a baseline height correspond to locations without object portions. Similarly, the size and shape of the deformed regions can correlate to the size and shape of the object portions. In some embodiments, the process of block 410 involves determining a height profile of the carrier film, and correlating the height profile to the geometry of the portion of the object. The height profile may represent the variations in height of the carrier film at the separation location, and may be determined at a single time point (e.g., from a single image) or determined at multiple time points (e.g., from a series of images). Optionally, multiple height profiles over time can be used to determine the overall shape and size of the object portion in at least two dimensions (e.g., in the X- and Y-directions).

The geometry of the object portion can be determined in many different ways, including computational approaches as heuristic methods, finite element analysis, machine learning models, etc., as discussed elsewhere herein. In some embodiments, one or more images depicting the deformation of the carrier film are input into a software algorithm, and the software algorithm can predict the corresponding geometry of the object portion that produced the deformation. For instance, the software algorithm can extract a height profile of the carrier film from the image data (e.g., using computer vision techniques) and can use the height profile to infer the location and geometry of the object portion. The output of the software algorithm can be a digital representation of the predicted geometry, such as a 2D image, 3D digital model, etc.

At block 412, the method 400 can detect whether a printing error is present. For instance, the determined geometry of the portion of the object can be compared to a target geometry for the portion of the object to detect whether a printing error is present. For instance, a digital representation of the target geometry (e.g., a target 2D image) can be compared to a digital representation of the determined geometry (e.g., a predicted 2D image) to determine locations where the determined geometry differs from the target geometry, optionally, the size (e.g., distance) of the discrepancy. In some embodiments, the deviation is computed using a loss function, such as mean squared error (MSE), mean absolute error (MAE), binary cross-entropy loss, categorical cross-entropy loss, dice loss, structural similarity index (SSIM), Huber loss, L1 loss, L2 loss, etc., or suitable combinations thereof. In some embodiments, a printing error is detected if the determined geometry deviates significantly from the target geometry (e.g., the deviation exceeds a predetermined threshold and/or occurs at an important portion of the object). The acceptable amount of deviation may be uniform across the entire object, or the acceptable amount of deviation may differ for different portions of the object (e.g., larger deviations may be acceptable for portions of the object that are less important for the proper function of the object).

If no printing error is detected, the method 400 can return to block 402 to fabricate the next portion (e.g., next layer) of the object. The method 400 can then be repeated until the entire object has been fabricated.

If a printing error is detected, the method 400 can proceed to block 414 with determining whether the printing error is correctable. The determination can be based on the size of the printing error (e.g., errors that are too large may be considered uncorrectable), the location of the printing error (e.g., errors that occur at critical locations of the object may be considered uncorrectable), the type of printing error (e.g., whether the error involves omission of material, deposition of excess material, insufficient curing of material, overcuring of material, incomplete separation of the object portion from the carrier film), and/or other relevant considerations

If the printing error is correctable, the method 400 can continue to block 416 with adjusting at least one printing parameter to correct the printing error. Adjustments may be made to any of the following printing parameters: a pattern of the applied energy, an energy dosage of the applied energy, an exposure time of the applied energy, a layer thickness of the curable material, a temperature of the curable material, a speed of the carrier film, a tension of the carrier film, or a scaling factor for the object. The adjustments may be based on the size, location, and/or type of printing error. For example, if the object portion is undercured (e.g., due to variations in consistency of the curable material), the energy dosage and/or exposure time may be increased for subsequent object portions. As another example, if the object portion is experiencing unwanted shrinkage or expansion (e.g., due to material and/or environmental factors), the scaling factors for subsequent object portions may be adjusted to compensate for such shrinkage/expansion. In a further example, if the carrier film deformation is too large (e.g., exceeds a threshold value), the tension of the carrier film may be increased to ensure overall printing quality.

Once the error has been corrected, the method 400 can return to block 402 to form the next object portion (e.g., next layer). The method 400 can then be repeated until the entire object has been fabricated.

If the printing error is not correctable, the method 400 can proceed to block 418 with terminating printing of the object. In some embodiments, it may be advantageous to continue printing other objects in the same batch that are not affected by the error to maintain high manufacturing throughput, while selectively terminating the printing of the object having the error to conserve materials that would be consumed in attempting to print that object and/or to reduce the likelihood of the error affecting the printing of the other objects. Optionally, the process of block 418 can also include terminating printing of one or more objects that are proximate to the object affected by the error (e.g., objects within the same zone or quadrant of the build platform as the affected object), while continuing printing of one or more objects that are sufficiently far away from the affected object (e.g., objects in a different zone or quadrant of the build platform as the affected object). The terminated object(s) can be reported (e.g., to an operator) so they can be rescheduled for a future printing operation.

The process of block 418 can be implemented in various ways. For example, the printing of the object may be terminated by removing the object from the fabrication instructions (e.g., digital data file) that are used to control the additive manufacturing system. In embodiments where the fabrication instructions include a digital representation of all the objects in the batch, the removal of the object affected by the error can be accomplished by masking, extracting, or deleting the part of the digital representation that depicts the affected object. For instance, masking may be performed by identifying a boundary of the digital representation that contains the affected object, and then applying a mask to all pixels within the boundary. In some embodiments, the masking operation includes one or more of the following: applying a logical AND with a white canvas and a black bounding box, direct manipulation of the digital representation in the system buffer, or applying a run length encoding for the digital representation in the buffer and performing a logical AND with an appropriate kernel.

Additional examples of techniques for error correction that are applicable to the present technology are provided in U.S. application Ser. No. 18/600,250, the disclosure of which is incorporated by reference herein in its entirety.

The processes of the method 400 can be repeated continuously during fabrication of one or more objects to provide a continuous feedback loop, in which each printed portion of each object is monitored, analyzed, and used to adjust the printing parameters in real-time. This adaptive mechanism can ensure that the fabrication process remains consistent and precise, even in the face of varying environmental and material conditions.

The method 400 illustrated in FIG. 4 can be modified in many different ways. For example, although the above processes of the method 400 are described with respect to a single object, the method 400 can be used to sequentially or concurrently fabricate any suitable number of objects, such as tens, hundreds, or thousands of objects. As another example, the ordering of the processes shown in FIG. 4 can be varied. Some of the processes of the method 400 can be omitted (e.g., the processes of blocks 414 and/or 418), and/or the method 400 can include additional processes not shown in FIG. 4 (e.g., the processes for determining object geometry based on recesses discussed below with respect to FIGS. 5 and 6).

FIG. 5 is a perspective view of a portion of a printer assembly 500 showing recesses 502 in a curable material 504 on a carrier film 506, in accordance with embodiments of the present technology. The printer assembly 500 can be identical or generally similar to the printer assembly 204 of FIG. 2. For instance, the carrier film 506 of the printer assembly 500 can convey the curable material 504 to an energy source (not shown) that selectively cures the curable material 504 to form cured object portions 508. After curing, the object portions 508 can be separated from the carrier film 506 and the remaining curable material 504, e.g., due to peel-off forces as the carrier film 506 wraps around a roller 510 downstream of the energy source. As described elsewhere herein, the remaining curable material 504 can include recesses 502, where the geometry (e.g., shape, size) of the recesses 502 correlates to the geometry of the object portions 508. Accordingly, the geometry of the object portions 508 can be indirectly determined based on the geometry of the recesses 502.

FIG. 6 is a flow diagram illustrating a method 600 for monitoring and/or correcting additive manufacturing of an object, in accordance with embodiments of the present technology. The method 600 can be used to fabricate many different types of objects, such any of the dental appliances described herein. The method 600 can be performed using any of the systems and devices described herein, such as the system 200 of FIG. 2 and/or the printer assembly 500 of FIG. 5. In some embodiments, some or all of the processes of the method 600 are implemented as computer-readable instructions (e.g., program code) that are configured to be executed by one or more processors of a computing device (e.g., a controller of an additive manufacturing system). The method 600 can be combined with any of the other methods described herein, such as the method 400 of FIG. 4.

The method 600 can include depositing a curable material on a carrier film (block 602), applying energy to the curable material to form a portion of an object (block 604), and separating the portion of the object from remaining curable material on the carrier film (block 606). The processes of blocks 602-606 may be identical or generally similar to the processes of blocks 402-406 of the method 400 of FIG. 4.

At block 608, the method 600 can include obtaining image data depicting a recess formed in the remaining curable material. As described elsewhere herein, the separation of the object portion from the remaining curable material can leave a recess (imprint) in the curable material. The image data can include photographs and/or video produced by one or more imaging devices (e.g., cameras) positioned proximate to the carrier film to image the recesses. In some embodiments, the image data includes a continuous stream of high-resolution images of the carrier film downstream of the separation location (e.g., the post-print zone), thereby providing real-time or near-real-time monitoring of the recesses in the curable material. Optionally, the image data can also depict a pattern projected onto the recess and/or curable material to facilitate visualization, e.g., as discussed further below with respect to FIGS. 7A-8.

At block 610, the method 600 can continue with determining a geometry of the portion of the object, based on the image data. As described elsewhere herein, the geometry of the recess can correlate to the geometry of the object portion, e.g., the shape and size of the recess can be substantially identical to the shape and size of the object portion. In some embodiments, one or more images depicting the recess are input into a software algorithm, and the software algorithm can predict the corresponding geometry of the object portion that produced the recess. For instance, the software algorithm can extract the shape and size of the recess from the image data (e.g., using computer vision techniques). The shape and size of the recess may be used directly as the shape and size of the object portion, or adjustments may be applied to calculate the shape and size of the object portion from the shape and size of the recess (e.g., to account for material shrinkage/expansion, viscoelastic flow, and/or other changes that may occur after separation). The output of the software algorithm can be a digital representation of the predicted geometry of the object portion, such as a 2D image, 3D digital model, etc.

At block 612, the method 600 can detect whether a printing error is present, based on the determined geometry. The process of block 612 may be identical or generally similar to the process of block 412 of the method 400 of FIG. 4.

If no printing error is detected, the method 600 can return to block 602 to fabricate the next portion (e.g., next layer) of the object. The method 600 can then be repeated until the entire object has been fabricated.

If a printing error is detected, the method 600 can proceed to block 614 with determining whether the printing error is correctable. The process of block 614 may be identical or generally similar to the process of block 414 of the method 400 of FIG. 4.

If the printing error is correctable, the method 600 can continue to block 616 with adjusting at least one printing parameter to correct the printing error. The process of block 616 may be identical or generally similar to the process of block 416 of the method 400 of FIG. 4. Once the error has been corrected, the method 600 can return to block 602 to form the next object portion (e.g., next layer). The method 600 can then be repeated until the entire object has been fabricated.

If the printing error is not correctable, the method 600 can proceed to block 618 with terminating printing of the object. The process of block 618 may be identical or generally similar to the process of block 418 of the method 400 of FIG. 4.

The processes of the method 600 can be repeated continuously during fabrication of one or more objects to provide a continuous feedback loop, in which each printed portion of each object is monitored, analyzed, and used to adjust the printing parameters in real-time. This adaptive mechanism can ensure that the fabrication process remains consistent and precise, even in the face of varying environmental and material conditions.

The method 600 illustrated in FIG. 6 can be modified in many different ways. For example, although the above processes of the method 600 are described with respect to a single object, the method 600 can be used to sequentially or concurrently fabricate any suitable number of objects, such as tens, hundreds, or thousands of objects. As another example, the ordering of the processes shown in FIG. 6 can be varied. Some of the processes of the method 600 can be omitted (e.g., the processes of blocks 614 and/or 618), and/or the method 600 can include additional processes not shown in FIG. 6 (e.g., the processes for determining object geometry based on film deformation discussed above with respect to FIGS. 3A-4).

FIGS. 7A-7D illustrate use of projected patterns for visualizing features in a curable material, in accordance with embodiments of the present technology. The techniques described with respect to FIGS. 7A-7D may be used to enhance visibility of carrier film deformation and/or recesses in a curable material (e.g., as discussed above in connection with FIGS. 3A-6). Alternatively or in combination, the techniques described with respect to FIGS. 7A-7D may be used to monitor other aspects of an additive manufacturing process. For instance, for systems that provides a continuous layer of material on a carrier film or other substrate (e.g., the system 200 of FIG. 2), it may be advantageous to monitor the amount of material being deposited on the carrier film (e.g., fill level) to avoid overfilling or underfilling, which may affect the consistency of the material layer. As another example, it may be advantageous to confirm that the material is deposited in a smooth, uniform layer on the carrier film, since irregularities in the material layer may produce defects in the printed objects. However, image-based monitoring of the deposited material may be challenging, particularly if the material is transparent or translucent and/or if the material is deposited in a relatively thin layer. In such situations, projection of a predetermined light pattern onto the material may facilitate visualization of material features indicative of printing errors. For instance, debris, bubbles, recesses, and/or other features that disrupt the smooth surface of the material will produce corresponding visible distortions of the projected pattern, and thus the distortions can be analyzed to determine the location, geometry, and amount of such features.

FIG. 7A is a perspective view of a portion of a printer assembly 700a including a plurality of projectors 702a, 702b, in accordance with embodiments of the present technology. The printer assembly 700a can be identical or generally similar to the printer assembly 204 of FIG. 2. For instance, the printer assembly 700a can include a deposition zone 704 in which a curable material 706 is deposited onto a carrier film 708 by a material source (not shown). A blade 710 can be present in the deposition zone 704 to smooth the curable material 706 into a relatively thin, uniform layer. Due to the flow restriction imposed by the blade 710, the curable material 706 may accumulate behind the blade 710 (“built-up material 712”). The height of the built-up material 712 may correlate to the amount of curable material 706 deposited onto the carrier film 708, and thus may be used to determine whether overfilling or underfilling has occurred.

In the illustrated embodiment, the printer assembly 700a includes a first projector 702a (e.g., a light projector or a laser) positioned at or proximate to the deposition zone 704 to output a pattern 714a of light onto the built-up material 712. The light can have any suitable wavelength, such as a visible wavelength, an infrared wavelength, or an ultraviolet wavelength. In some embodiments, the wavelength does not cause curing and/or other photo-initiated reactions in the curable material 706, e.g., the wavelength is different than the curing wavelength of the curable material 706.

The pattern 714a can be any combination of geometric elements having a known shape, size, and spatial relationship to each other, such as one or more points, lines (e.g., straight lines, curved lines), shapes (e.g., squares, triangles, circles), etc. In the illustrated embodiment, the pattern 714a includes a plurality of lines arranged into a grid having a predetermined shape, size, and spacing. Due to the variations in the height of the built-up material 712, the pattern 714a is distorted when projected on the built-up material 712, e.g., the shape, size, and spacing of the projected pattern 714a differs from the original pattern 714a (e.g., the shape, size, and spacing of the pattern 714a if it were to be projected onto a flat surface). Accordingly, the locations and extent of the distortion can be used to infer the height of the built-up material 712.

An imaging device 716a (e.g., a camera) can be used to obtain image data (e.g., one or more photographs, videos) of the built-up material 712 and the projected pattern 714a. The image data can be analyzed to identify the distortions in the projected pattern 714a (e.g., using computer vision techniques). For instance, the geometry (e.g., shape, size, spacing) of the projected pattern 714a can be compared to the original geometry of the pattern 714a to identify the locations and extent of any distortions that are present. The identified distortions can then be used to determine the height of the built-up material 712. The determined height can then be used to determine whether any adjustments to the additive manufacturing process should be made. For example, if the determined height exceeds a target height, the deposition rate of the curable material 706 can be decreased; if the determined height is below a target height, the deposition rate of the curable material 706 can be increased; etc.

As shown in FIG. 7A, the printer assembly 700a includes a second projector 702b (e.g., a light projector or a laser) positioned at or proximate to the deposition zone 704 to output a pattern 714b of light onto one or more recesses 718 in the curable material 706. The recesses 718 may be imprints left by separation of cured object portions from the curable material 706, as previously described. The pattern 714b may be generally similar to the pattern 714a, e.g., the pattern 714b can include one or more geometric elements having a known shape, size, spatial relationship, etc. An imaging device 716b (e.g., a camera) can be used to obtain image data (e.g., one or more photographs, videos) of the recesses 718 and the projected pattern 714b. The image data can be analyzed to identify the distortions in the projected pattern 714b (e.g., using computer vision techniques). For instance, the geometry (e.g., shape, size, spacing) of the projected pattern 714b can be compared to the original geometry of the pattern 714b to identify the locations and extent of any distortions that are present. The identified distortions can then be used to determine the locations and geometry of the recesses 718. The locations and geometries of the recesses 718 can be used to detect printing errors, e.g., as previously described in connection with FIGS. 5 and 6.

Although FIG. 7A illustrates two projectors 702a, 702b that project respective patterns 714a, 714b onto two different locations of the deposition zone 704, in other embodiments, a different number of projectors can be used, such as one, three, four, five, or more projectors. Some or all of the projectors may project the same or different patterns. Some or all of the projectors may project patterns onto the same location (e.g., for redundancy and/or improved accuracy), or some or all of the projectors may project patterns onto different locations. The number and locations of the projectors, as well as the type of patterns projected, may vary according to the type of monitoring to be performed, e.g., different patterns may be used for monitoring material height, recess shape, presence of irregularities (e.g., streaks, debris, bubbles), etc. Moreover, although FIG. 7A illustrates two imaging devices 716a, 716b that image the two patterns 714a, 714b, in other embodiments, a different number of imaging devices can be used, such as one, three, four, five, or more imaging devices. Any of the imaging devices may image a single pattern or may image multiple patterns.

FIG. 7B is a perspective view of a portion of a printer assembly 700b including a projector 702c, in accordance with embodiments of the present technology. The printer assembly 700b can be generally similar to the printer assembly 700a of FIG. 7A, except that the printer assembly 700b includes a single projector 702c that outputs a pattern 714c of light (e.g., a grid) over multiple locations of the curable material 706 in the deposition zone 704 (e.g., both the built-up material 712 and the recesses 718), and a single imaging device 716c that obtains image data depicting the projected pattern 714c. The configuration used in FIG. 7B may be used to detect printing errors in multiple locations concurrently, e.g., by determining the height of the built-up material 712 to evaluate fill level while also monitoring the recesses 718 to detect errors in the geometry of the printed parts.

FIG. 7C is a perspective view of a portion of a portion of a printer assembly 700c including a projector 702d, in accordance with embodiments of the present technology. The printer assembly 700c may be generally similar to the embodiments of FIGS. 7A and 7B, except that the projector 702d is configured to output a pattern 714d of light (e.g., a grid) specifically onto the built-up material 712 behind the blade 710. Debris 720 trapped within the built-up material 712 (e.g., cured object portions that failed to separate from the carrier film 708, other unwanted residue) may produce a bump in the surface of the built-up material 712 that affects the projected pattern 714d. Specifically, the distortion of the pattern 714d at or near the debris 720 may differ from the distortion of the pattern 714d at locations away from the debris 720. The location and geometry of the distortion may correlate to the location and geometry of the debris 720. Accordingly, image data produced by an imaging device 716d depicting the projected pattern 714d may be analyzed to provide information regarding the size, shape, and/or location of the debris 720 in the built-up material 712, which in turn may be used to determine the appropriate adjustments to the additive manufacturing process to resolve this issue (e.g., pausing the print operation and/or outputting an alert to an operator to remove the debris 720).

FIG. 7D is a perspective view of a portion of a portion of a printer assembly 700d including a projector 702e, in accordance with embodiments of the present technology. The printer assembly 700d may be generally similar to the embodiments of FIGS. 7A-7C, except that the projector 702e is configured to output a pattern 714e of light (e.g., a line) specifically onto the curable material 706 downstream of the blade 710. This configuration can be used to detect streaks 722, debris, variable layer thickness, and/or other issues with the uniformity of the curable material 706 on the carrier film 708. For instance, the projected pattern 714e may be distorted at locations where streaks 722 and/or other uniformity issues are present in the curable material 706. Accordingly, image data produced by an imaging device 716e depicting the projected pattern 714e may be analyzed to provide information regarding the size, shape, and/or location of the streaks 722 (and/or other uniformity issues present in the curable material 706), which in turn may be used to determine the appropriate adjustments to the additive manufacturing process to resolve this issue (e.g., increasing deposition rate of the curable material 706 to eliminate the streaks 722, pausing the print operation, and/or outputting an alert to an operator).

FIG. 8 is a flow diagram illustrating a method 800 for monitoring and/or correcting additive manufacturing of an object, in accordance with embodiments of the present technology. The method 800 can be performed using any of the systems and devices described herein, such as the system 200 of FIG. 2, the printer assembly 300 of FIGS. 3A-3E, the printer assembly 500 of FIG. 5, and/or the printer assemblies 700a-700d of FIGS. 7A-7D. In some embodiments, some or all of the processes of the method 800 are implemented as computer-readable instructions (e.g., program code) that are configured to be executed by one or more processors of a computing device (e.g., a controller of an additive manufacturing system). The method 800 can be combined with any of the other methods described herein, such as the method 400 of FIG. 4 and/or the method 600 of FIG. 6.

The method 800 can begin at block 802 with depositing a curable material on a carrier film. The process of block 802 may be identical or generally similar to the process of block 402 of the method 400 of FIG. 4.

At block 804, the method 800 can include projecting a pattern onto the curable material. The pattern can include one or more points, lines (e.g., straight lines, curved lines), shapes (e.g., squares, triangles, circles), and/or other geometric elements having a predetermined shape, size, and spatial relationship to each other. For instance, the pattern can be a grid composed of lines arranged in a predetermined spacing. The pattern can be produced by a projector that outputs light of a suitable wavelength, such as a visible wavelength, an infrared wavelength, an ultraviolet wavelength, or other wavelength that is different than the curing wavelength of the curable material.

The pattern can be projected onto any location of the curable material where monitoring is desired, such as a deposition zone, a pre-print zone, a print zone, and/or a post-print zone. For instance, the pattern can be projected onto curable material that is built up behind a blade in the deposition zone to monitor the fill level of the curable material and/or check for the presence of debris. As another example, the pattern can be projected onto curable material in the pre-print zone to check for streaks, debris, bubbles, and/or other issues affecting the uniformity of the material layer. In a further example, the pattern can be projected onto curable material and/or cured object portions in the print zone to monitor the curing process. In yet another example, the pattern can be projected onto curable material in the post-print zone to monitor recesses left by separation of the cured object portions from the carrier film.

At block 806, the method 800 can include obtaining image data depicting the projected pattern. The image data can include photographs and/or video produced by one or more imaging devices (e.g., cameras) positioned proximate to the carrier film to image the projected pattern. In some embodiments, the image data includes a continuous stream of high-resolution images of the projected pattern and surrounding curable material, thereby providing real-time or near-real-time monitoring of the curable material.

At block 808, the method 800 can continue with identifying a distortion in the projected pattern, based on the image data. The identifying can include analyzing the image data to determine the geometry (e.g., shape, size, spacing) of the projected pattern, and then comparing the determined geometry to the original geometry of the pattern to determine the location and/or geometry of the distortion.

At block 810, the method 800 can include detecting a printing error, based on the identified distortion. As described herein, distortions may be present at locations where the curable material exhibits variations in height, smoothness, uniformity, etc., e.g., due to the presence of debris, recesses, streaks, and/or other features that disrupt the surface of the curable material. The location and/or geometry of the distortion can be used to infer whether any printing errors have occurred. For example, the distortion can be used to determine the locations and/or geometries of recesses in the curable material, which in turn can be used to determine the locations and/or geometries of the corresponding object portions and thus whether the actual geometry of the object portions deviate from the target geometry. As another example, the distortion can be used to monitor the height of the curable material (e.g., the height of built-up material behind a blade), which in turn can be used to determine the fill level of the material and thus whether the material deposition rate is satisfactory. In a further example, the distortion can be used to detect debris, streaks, and/or other irregularities present in the curable material. Based on the detected printing error, appropriate corrective actions may be taken, such as adjusting one or more printing parameters, terminating printing of one or more objects, alerting an operator, etc., as described elsewhere herein.

Although certain embodiments herein are described in terms of monitoring a curable material on a carrier film, the techniques herein may also be applied to monitor the carrier film itself. For instance, the speed, position (e.g., in the Y-direction), tension, length, slippage, etc., of the carrier film may be monitored using one or more imaging devices to detect issues that may lead to printing errors, such as speed mismatch between the carrier film and build platform, too much or too little film tension, slippage of the film, debris on the carrier film, etc. Monitoring of the carrier film may be performed using projected patterns on the carrier film (e.g., as described with respect to FIGS. 7A-8), markers on the carrier film, or on an unmodified carrier film.

Moreover, although certain embodiments are described herein with respect to monitoring of a curable material and/or recesses on a carrier film, the present technology is applicable to monitoring of other substrates that support a curable material during additive manufacturing, such as a stationary window in a vat-based or recoater-based additive manufacturing system.

### II. Dental Appliances and Associated Methods

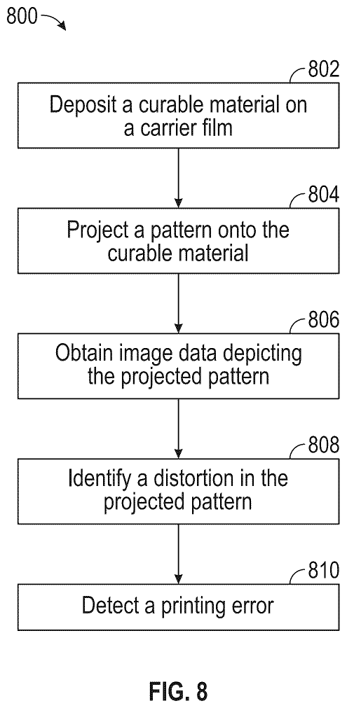

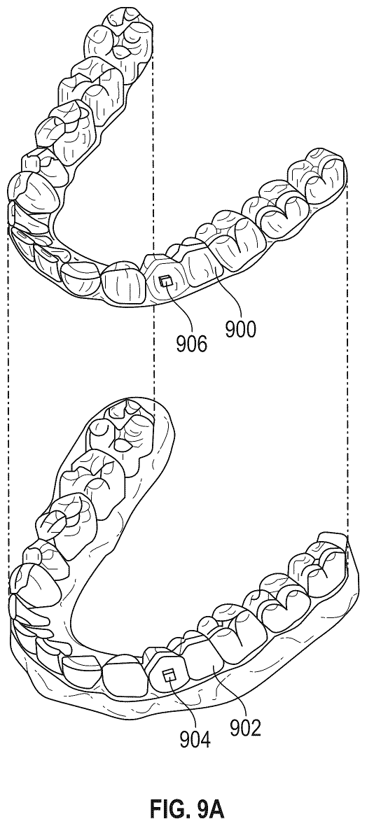

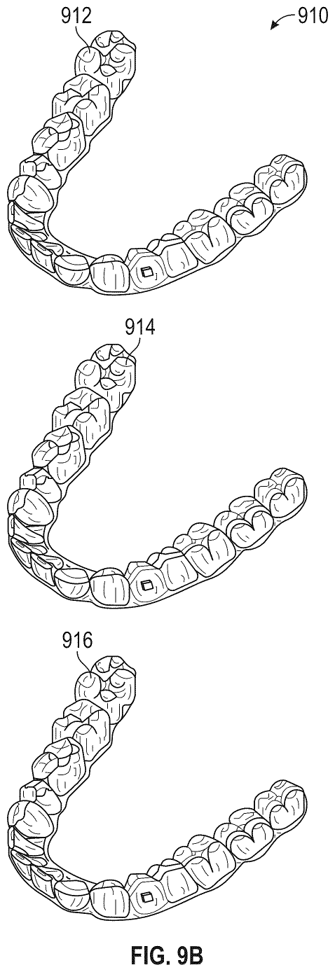

FIG. 9A illustrates a representative example of a tooth repositioning appliance 900 configured in accordance with embodiments of the present technology. The appliance 900 can be manufactured using any of the systems, methods, and devices described herein. The appliance 900 (also referred to herein as an “aligner”) can be worn by a patient in order to achieve an incremental repositioning of individual teeth 902 in the jaw. The appliance 900 can include a shell (e.g., a continuous polymeric shell or a segmented shell) having teeth-receiving cavities that receive and resiliently reposition the teeth. The appliance 900 or portion(s) thereof may be indirectly fabricated using a physical model of teeth. For example, an appliance (e.g., polymeric appliance) can be formed using a physical model of teeth and a sheet of suitable layers of polymeric material. In some embodiments, a physical appliance is directly fabricated, e.g., using additive manufacturing techniques, from a digital model of an appliance.

The appliance 900 can fit over all teeth present in an upper or lower jaw, or less than all of the teeth. The appliance 900 can be designed specifically to accommodate the teeth of the patient (e.g., the topography of the tooth-receiving cavities matches the topography of the patient's teeth), and may be fabricated based on positive or negative models of the patient's teeth generated by impression, scanning, and the like. Alternatively, the appliance 900 can be a generic appliance configured to receive the teeth, but not necessarily shaped to match the topography of the patient's teeth. In some cases, only certain teeth received by the appliance 900 are repositioned by the appliance 900 while other teeth can provide a base or anchor region for holding the appliance 900 in place as it applies force against the tooth or teeth targeted for repositioning. In some cases, some, most, or even all of the teeth can be repositioned at some point during treatment. Teeth that are moved can also serve as a base or anchor for holding the appliance as it is worn by the patient. In preferred embodiments, no wires or other means are provided for holding the appliance 900 in place over the teeth. In some cases, however, it may be desirable or necessary to provide individual attachments 904 or other anchoring elements on teeth 902 with corresponding receptacles 906 or apertures in the appliance 900 so that the appliance 900 can apply a selected force on the tooth. Representative examples of appliances, including those utilized in the Invisalign® System, are described in numerous patents and patent applications assigned to Align Technology, Inc. including, for example, in U.S. Pat. Nos. 6,450,807, and 5,975,893, as well as on the company's website, which is accessible on the World Wide Web (see, e.g., the url “invisalign.com”). Examples of tooth-mounted attachments suitable for use with orthodontic appliances are also described in patents and patent applications assigned to Align Technology, Inc., including, for example, U.S. Pat. Nos. 6,309,215 and 6,830,450.

FIG. 9B illustrates a tooth repositioning system 910 including a plurality of appliances 912, 914, 916, in accordance with embodiments of the present technology. Any of the appliances described herein can be designed and/or provided as part of a set of a plurality of appliances used in a tooth repositioning system. Each appliance may be configured so a tooth-receiving cavity has a geometry corresponding to an intermediate or final tooth arrangement intended for the appliance. The patient's teeth can be progressively repositioned from an initial tooth arrangement to a target tooth arrangement by placing a series of incremental position adjustment appliances over the patient's teeth. For example, the tooth repositioning system 910 can include a first appliance 912 corresponding to an initial tooth arrangement, one or more intermediate appliances 914 corresponding to one or more intermediate arrangements, and a final appliance 916 corresponding to a target arrangement. A target tooth arrangement can be a planned final tooth arrangement selected for the patient's teeth at the end of all planned orthodontic treatment. Alternatively, a target arrangement can be one of some intermediate arrangements for the patient's teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient's teeth that follows one or more incremental repositioning stages. Likewise, an initial tooth arrangement can be any initial arrangement for the patient's teeth that is followed by one or more incremental repositioning stages.

FIG. 9C illustrates a method 920 of orthodontic treatment using a plurality of appliances, in accordance with embodiments of the present technology. The method 920 can be practiced using any of the appliances or appliance sets described herein. In block 922, a first orthodontic appliance is applied to a patient's teeth in order to reposition the teeth from a first tooth arrangement to a second tooth arrangement. In block 924, a second orthodontic appliance is applied to the patient's teeth in order to reposition the teeth from the second tooth arrangement to a third tooth arrangement. The method 920 can be repeated as necessary using any suitable number and combination of sequential appliances in order to incrementally reposition the patient's teeth from an initial arrangement to a target arrangement. The appliances can be generated all at the same stage or in sets or batches (e.g., at the beginning of a stage of the treatment), or the appliances can be fabricated one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable in order to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied in order to compensate for any inaccuracies or limitations of the appliance.

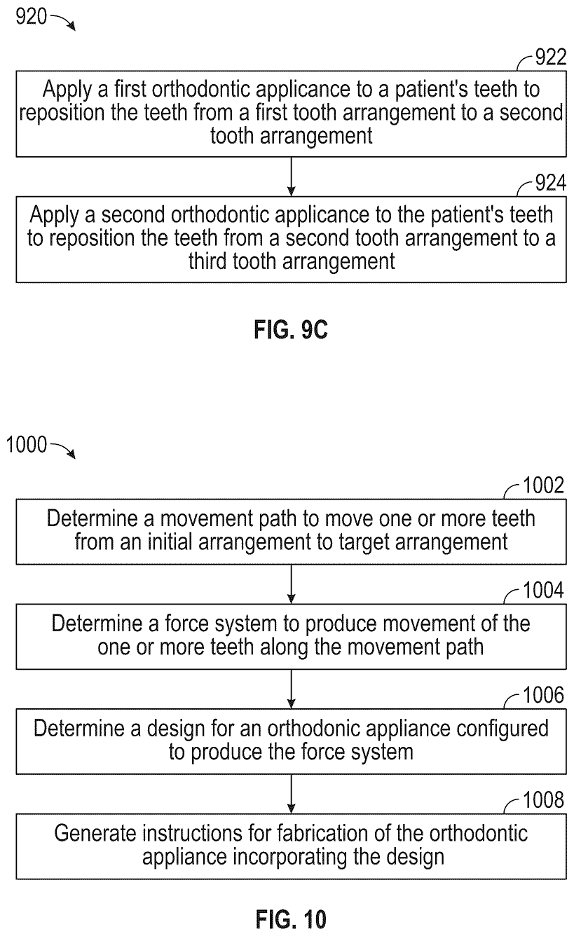

FIG. 10 illustrates a method 1000 for designing an orthodontic appliance, in accordance with embodiments of the present technology. The method 1000 can be applied to any embodiment of the orthodontic appliances described herein. Some or all of the steps of the method 1000 can be performed by any suitable data processing system or device, e.g., one or more processors configured with suitable instructions.

In block 1002, a movement path to move one or more teeth from an initial arrangement to a target arrangement is determined. The initial arrangement can be determined from a mold or a scan of the patient's teeth or mouth tissue, e.g., using wax bites, direct contact scanning, x-ray imaging, tomographic imaging, sonographic imaging, and other techniques for obtaining information about the position and structure of the teeth, jaws, gums and other orthodontically relevant tissue. From the obtained data, a digital data set can be derived that represents the initial (e.g., pretreatment) arrangement of the patient's teeth and other tissues. Optionally, the initial digital data set is processed to segment the tissue constituents from each other. For example, data structures that digitally represent individual tooth crowns can be produced. Advantageously, digital models of entire teeth can be produced, including measured or extrapolated hidden surfaces and root structures, as well as surrounding bone and soft tissue.

The target arrangement of the teeth (e.g., a desired and intended end result of orthodontic treatment) can be received from a clinician in the form of a prescription, can be calculated from basic orthodontic principles, and/or can be extrapolated computationally from a clinical prescription. With a specification of the desired final positions of the teeth and a digital representation of the teeth themselves, the final position and surface geometry of each tooth can be specified to form a complete model of the tooth arrangement at the desired end of treatment.

Having both an initial position and a target position for each tooth, a movement path can be defined for the motion of each tooth. In some embodiments, the movement paths are configured to move the teeth in the quickest fashion with the least amount of round-tripping to bring the teeth from their initial positions to their desired target positions. The tooth paths can optionally be segmented, and the segments can be calculated so that each tooth's motion within a segment stays within threshold limits of linear and rotational translation. In this way, the end points of each path segment can constitute a clinically viable repositioning, and the aggregate of segment end points can constitute a clinically viable sequence of tooth positions, so that moving from one point to the next in the sequence does not result in a collision of teeth.

In block 1004, a force system to produce movement of the one or more teeth along the movement path is determined. A force system can include one or more forces and/or one or more torques. Different force systems can result in different types of tooth movement, such as tipping, translation, rotation, extrusion, intrusion, root movement, etc. Biomechanical principles, modeling techniques, force calculation/measurement techniques, and the like, including knowledge and approaches commonly used in orthodontia, may be used to determine the appropriate force system to be applied to the tooth to accomplish the tooth movement. In determining the force system to be applied, sources may be considered including literature, force systems determined by experimentation or virtual modeling, computer-based modeling, clinical experience, minimization of unwanted forces, etc.

Determination of the force system can be performed in a variety of ways. For example, in some embodiments, the force system is determined on a patient-by-patient basis, e.g., using patient-specific data. Alternatively or in combination, the force system can be determined based on a generalized model of tooth movement (e.g., based on experimentation, modeling, clinical data, etc.), such that patient-specific data is not necessarily used. In some embodiments, determination of a force system involves calculating specific force values to be applied to one or more teeth to produce a particular movement. Alternatively, determination of a force system can be performed at a high level without calculating specific force values for the teeth. For instance, block 1004 can involve determining a particular type of force to be applied (e.g., extrusive force, intrusive force, translational force, rotational force, tipping force, torquing force, etc.) without calculating the specific magnitude and/or direction of the force.

The determination of the force system can include constraints on the allowable forces, such as allowable directions and magnitudes, as well as desired motions to be brought about by the applied forces. For example, in fabricating palatal expanders, different movement strategies may be desired for different patients. For example, the amount of force needed to separate the palate can depend on the age of the patient, as very young patients may not have a fully-formed suture. Thus, in juvenile patients and others without fully-closed palatal sutures, palatal expansion can be accomplished with lower force magnitudes. Slower palatal movement can also aid in growing bone to fill the expanding suture. For other patients, a more rapid expansion may be desired, which can be achieved by applying larger forces. These requirements can be incorporated as needed to choose the structure and materials of appliances; for example, by choosing palatal expanders capable of applying large forces for rupturing the palatal suture and/or causing rapid expansion of the palate. Subsequent appliance stages can be designed to apply different amounts of force, such as first applying a large force to break the suture, and then applying smaller forces to keep the suture separated or gradually expand the palate and/or arch.

The determination of the force system can also include modeling of the facial structure of the patient, such as the skeletal structure of the jaw and palate. Scan data of the palate and arch, such as X-ray data or 3D optical scanning data, for example, can be used to determine parameters of the skeletal and muscular system of the patient's mouth, so as to determine forces sufficient to provide a desired expansion of the palate and/or arch. In some embodiments, the thickness and/or density of the mid-palatal suture may be measured, or input by a treating professional. In other embodiments, the treating professional can select an appropriate treatment based on physiological characteristics of the patient. For example, the properties of the palate may also be estimated based on factors such as the patient's age—for example, young juvenile patients can require lower forces to expand the suture than older patients, as the suture has not yet fully formed.

In block 1006, a design for an orthodontic appliance configured to produce the force system is determined. The design can include the appliance geometry, material composition and/or material properties, and can be determined in various ways, such as using a treatment or force application simulation environment. A simulation environment can include, e.g., computer modeling systems, biomechanical systems or apparatus, and the like. Optionally, digital models of the appliance and/or teeth can be produced, such as finite element models. The finite element models can be created using computer program application software available from a variety of vendors. For creating solid geometry models, computer aided engineering (CAE) or computer aided design (CAD) programs can be used, such as the AutoCAD® software products available from Autodesk, Inc., of San Rafael, CA. For creating finite element models and analyzing them, program products from a number of vendors can be used, including finite element analysis packages from ANSYS, Inc., of Canonsburg, PA, and SIMULIA (Abaqus) software products from Dassault Systèmes of Waltham, MA.

Optionally, one or more designs can be selected for testing or force modeling. As noted above, a desired tooth movement, as well as a force system required or desired for eliciting the desired tooth movement, can be identified. Using the simulation environment, a candidate design can be analyzed or modeled for determination of an actual force system resulting from use of the candidate appliance. One or more modifications can optionally be made to a candidate appliance, and force modeling can be further analyzed as described, e.g., in order to iteratively determine an appliance design that produces the desired force system.

In block 1008, instructions for fabrication of the orthodontic appliance incorporating the design are generated. The instructions can be configured to control a fabrication system or device in order to produce the orthodontic appliance with the specified design. In some embodiments, the instructions are configured for manufacturing the orthodontic appliance using direct fabrication (e.g., stereolithography, selective laser sintering, fused deposition modeling, 3D printing, continuous direct fabrication, multi-material direct fabrication, etc.), in accordance with the various methods presented herein. In alternative embodiments, the instructions can be configured for indirect fabrication of the appliance, e.g., by thermoforming.

Although the above steps show a method 1000 of designing an orthodontic appliance in accordance with some embodiments, a person of ordinary skill in the art will recognize some variations based on the teaching described herein. Some of the steps may comprise sub-steps. Some of the steps may be repeated as often as desired. One or more steps of the method 1000 may be performed with any suitable fabrication system or device, such as the embodiments described herein. Some of the steps may be optional, e.g., the process of block 1004 can be omitted, such that the orthodontic appliance is designed based on the desired tooth movements and/or determined tooth movement path, rather than based on a force system. Moreover, the order of the steps can be varied as desired.

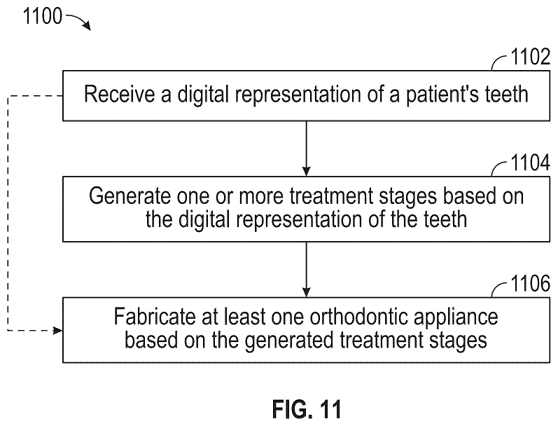

FIG. 11 illustrates a method 1100 for digitally planning an orthodontic treatment and/or design or fabrication of an appliance, in accordance with embodiments. The method 1100 can be applied to any of the treatment procedures described herein and can be performed by any suitable data processing system.

In block 1102, a digital representation of a patient's teeth is received. The digital representation can include surface topography data for the patient's intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

In block 1104, one or more treatment stages are generated based on the digital representation of the teeth. The treatment stages can be incremental repositioning stages of an orthodontic treatment procedure designed to move one or more of the patient's teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

In block 1106, at least one orthodontic appliance is fabricated based on the generated treatment stages. For example, a set of appliances can be fabricated, each shaped according to a tooth arrangement specified by one of the treatment stages, such that the appliances can be sequentially worn by the patient to incrementally reposition the teeth from the initial arrangement to the target arrangement. The appliance set may include one or more of the orthodontic appliances described herein. The fabrication of the appliance may involve creating a digital model of the appliance to be used as input to a computer-controlled fabrication system. The appliance can be formed using direct fabrication methods, indirect fabrication methods, or combinations thereof, as desired.

In some instances, staging of various arrangements or treatment stages may not be necessary for design and/or fabrication of an appliance. As illustrated by the dashed line in FIG. 11, design and/or fabrication of an orthodontic appliance, and perhaps a particular orthodontic treatment, may include use of a representation of the patient's teeth (e.g., including receiving a digital representation of the patient's teeth (block 1102)), followed by design and/or fabrication of an orthodontic appliance based on a representation of the patient's teeth in the arrangement represented by the received representation.

As noted herein, the techniques described herein can be used for the direct fabrication of dental appliances, such as aligners and/or a series of aligners with tooth-receiving cavities configured to move a person's teeth from an initial arrangement toward a target arrangement in accordance with a treatment plan. Aligners can include mandibular repositioning elements, such as those described in U.S. Pat. No. 10,912,629, entitled “Dental Appliances with Repositioning Jaw Elements,” filed Nov. 30, 2015; U.S. Pat. No. 10,537,406, entitled “Dental Appliances with Repositioning Jaw Elements,” filed Sep. 19, 2014; and U.S. Pat. No. 9,844,424, entitled “Dental Appliances with Repositioning Jaw Elements,” filed Feb. 21, 2014; all of which are incorporated by reference herein in their entirety.

The techniques used herein can also be used to manufacture attachment placement devices, e.g., appliances used to position prefabricated attachments on a person's teeth in accordance with one or more aspects of a treatment plan. Examples of attachment placement devices (also known as “attachment placement templates” or “attachment fabrication templates”) can be found at least in: U.S. application Ser. No. 17/249,218, entitled “Flexible 3D Printed Orthodontic Device,” filed Feb. 24, 2021; U.S. application Ser. No. 16/366,686, entitled “Dental Attachment Placement Structure,” filed Mar. 27, 2019; U.S. application Ser. No. 15/674,662, entitled “Devices and Systems for Creation of Attachments,” filed Aug. 11, 2017; U.S. Pat. No. 11,103,330, entitled “Dental Attachment Placement Structure,” filed Jun. 14, 2017; U.S. application Ser. No. 14/963,527, entitled “Dental Attachment Placement Structure,” filed Dec. 9, 2015; U.S. application Ser. No. 14/939,246, entitled “Dental Attachment Placement Structure,” filed Nov. 12, 2015; U.S. application Ser. No. 14/939,252, entitled “Dental Attachment Formation Structures,” filed Nov. 12, 2015; and U.S. Pat. No. 9,700,385, entitled “Attachment Structure,” filed Aug. 22, 2014; all of which are incorporated by reference herein in their entirety.

The techniques described herein can be used to make incremental palatal expanders and/or a series of incremental palatal expanders used to expand a person's palate from an initial position toward a target position in accordance with one or more aspects of a treatment plan. Examples of incremental palatal expanders can be found at least in: U.S. application Ser. No. 16/380,801, entitled “Releasable Palatal Expanders,” filed Apr. 10, 2019; U.S. application Ser. No. 16/022,552, entitled “Devices, Systems, and Methods for Dental Arch Expansion,” filed Jun. 28, 2018; U.S. Pat. No. 11,045,283, entitled “Palatal Expander with Skeletal Anchorage Devices,” filed Jun. 8, 2018; U.S. application Ser. No. 15/831,159, entitled “Palatal Expanders and Methods of Expanding a Palate,” filed Dec. 4, 2017; U.S. Pat. No. 10,993,783, entitled “Methods and Apparatuses for Customizing a Rapid Palatal Expander,” filed Dec. 4, 2017; and U.S. Pat. No. 7,192,273, entitled “System and Method for Palatal Expansion,” filed Aug. 7, 2003; all of which are incorporated by reference herein in their entirety.

### EXAMPLES

The following examples are included to further describe some aspects of the present technology, and should not be used to limit the scope of the technology.

Example 1. A method comprising:
depositing a curable material on a carrier film;
applying energy to the curable material on the carrier film to form a portion of an object;
separating the portion of the object from remaining curable material on the carrier film;
obtaining image data depicting a recess formed in the remaining curable material by the separation of the portion of the object; and
determining a geometry of the portion of the object based on the image data.

Example 2. The method of Example 1, wherein the image data is generated by an imaging device positioned proximate to the carrier film.

Example 3. The method of Example 1 or 2, wherein the energy is applied to the curable material at a print zone of a printer assembly, and the separation of the portion of the object occurs at a location of the printer assembly downstream of the print zone.

Example 4. The method of any one of Examples 1 to 3, wherein the carrier film is conveyed in a loop trajectory via one or more rollers, and wherein the separation of the portion of the object occurs at a location proximate to one of the one or more rollers.

Example 5. The method of any one of Examples 1 to 4, further comprising determining a geometry of the recess based on the image data, wherein the geometry of the portion of the object is determined based on the geometry of the recess.

Example 6. The method of Example 5, further comprising projecting a pattern onto the recess and the remaining curable material, wherein the image data depicts the recess with the projected pattern thereon and the geometry of the recess is determined based on the projected pattern.

Example 7. The method of Example 6, wherein the pattern comprises one or more lines.

Example 8. The method of Example 6 or 7, further comprising identifying a distortion in the projected pattern attributable to the presence of the recess, wherein the geometry of the recess is determined based on the distortion.

Example 9. The method of any one of Examples 1 to 8, further comprising comparing the determined geometry to a target geometry for the portion of the object.

Example 10. The method of Example 9, further comprising detecting a printing error based on the comparison.

Example 11. The method of Example 10, further comprising adjusting a printing parameter in response to the detected printing error.

Example 12. The method of Example 11, wherein the adjustment comprises an adjustment to one or more of the following: a pattern of the applied energy, an energy dosage of the applied energy, an exposure time of the applied energy, a layer thickness of the curable material, a temperature of the curable material, a speed of the carrier film, a tension of the carrier film, or a scaling factor for the object.

Example 13. The method of Example 11 or 12, further comprising forming a subsequent portion of the object from the curable material with the adjusted printing parameter.

Example 14. The method of any one of Examples 10 to 12, further comprising terminating printing of the object in response to the detected printing error.

Example 15. The method of Example 14, wherein the printing of the object is terminated by masking the object in a digital data file used to control the application of the energy.

Example 16. The method of Example 14 or 15, further comprising continuing printing of one or more additional objects.

Example 17. The method of any one of Examples 1 to 16, further obtaining second image data of the curable material on the carrier film, wherein the operations further comprise adjusting a printing parameter based on the second image data.

Example 18. The method of Example 17, wherein the adjustment comprises an adjustment to one or more of the following: a pattern of the applied energy, an energy dosage of the applied energy, an exposure time of the applied energy, a layer thickness of the curable material, a temperature of the curable material, a speed of the carrier film, a tension of the carrier film, or a scaling factor for the object.

Example 19. The method of any one of Examples 1 to 18, wherein the curable material is transparent or translucent.

Example 20. The method of any one of Examples 1 to 19, wherein the curable material comprises a photopolymerizable resin.

Example 21. The method of any one of Examples 1 to 20, wherein the object is a dental appliance.

Example 22. A system comprising:
a carrier film configured to support a curable material;
an energy source configured to apply energy to the curable material on the carrier film to form a portion of an object on a build platform;
a drive mechanism configured to cause separation of remaining curable material on the carrier film from the portion of the object;
an imaging device;
one or more processors; and
a memory comprising instructions that, when executed by the one or more processors, cause the system to perform operations comprising:
   obtaining, via the imaging device, image data depicting a recess formed in the remaining curable material by the separation, and
   determining a geometry of the portion of the object based on the image data.

Example 23. The system of Example 22, wherein the imaging device is positioned proximate to the carrier film.

Example 24. The system of Example 22 or 23, wherein the energy is applied to the curable material at a print zone of the system and the separation of the portion of the object occurs at a location of the system downstream of the print zone.

Example 25. The system of any one of Examples 22 to 24, wherein the drive mechanism comprises a roller and the separation of the portion of the object occurs at a location proximate to the roller.

Example 26. The system of any one of Examples 22 to 25, wherein the operations further comprise determining a geometry of the recess based on the image data, wherein the geometry of the portion of the object is determined based on the geometry of the recess.

Example 27. The system of Example 26, further comprising a light source configured to project a pattern onto the recess and the remaining curable material, wherein the image data depicts the recess with the projected pattern thereon and the geometry of the recess is determined based on the projected pattern.

Example 28. The system of Example 27, wherein the pattern comprises one or more lines.

Example 29. The system of Example 27 or 28, wherein the operations further comprise identifying a distortion in the projected pattern attributable to the presence of the recess, wherein the geometry of the recess is determined based on the distortion.

Example 30. The system of any one of Examples 22 to 29, wherein the operations further comprise comparing the determined geometry to a target geometry for the portion of the object.

Example 31. The system of Example 30, wherein the operations further comprise detecting a printing error based on the comparison.

Example 32. The system of Example 31, wherein the operations further comprise adjusting a printing parameter in response to the detected printing error.

Example 33. The system of Example 32, wherein the adjustment comprises an adjustment to one or more of the following: a pattern of the applied energy, an energy dosage of the applied energy, an exposure time of the applied energy, a layer thickness of the curable material, a temperature of the curable material, a speed of the carrier film, a tension of the carrier film, or a scaling factor for the object.

Example 34. The system of Example 32 or 33, wherein the operations further comprise forming a subsequent portion of the object from the curable material with the adjusted printing parameter.

Example 35. The system of any one of Examples 31 to 33, wherein the operations further comprise terminating printing of the object in response to the detected printing error.

Example 36. The system of Example 35, wherein the printing of the object is terminated by masking the object in a digital data file used to control the application of the energy.

Example 37. The system of Example 35 or 36, wherein the operations further comprise continuing printing of one or more additional objects.

Example 38. The system of any one of Examples 22 to 37, further comprising a second imaging device configured to obtain second image data of the curable material on the carrier film, wherein the operations further comprise adjusting a printing parameter based on the second image data.

Example 39. The system of Example 38, wherein the adjustment comprises an adjustment to one or more of the following: a pattern of the applied energy, an energy dosage of the applied energy, an exposure time of the applied energy, a layer thickness of the curable material, a temperature of the curable material, a speed of the carrier film, a tension of the carrier film, or a scaling factor for the object.

Example 40. The system of any one of Examples 22 to 39, wherein the curable material is transparent or translucent.

Example 41. The system of any one of Examples 22 to 40, wherein the curable material comprises a photopolymerizable resin.

Example 42. The system of any one of Examples 22 to 41, wherein the object is a dental appliance.

Example 43. A non-transitory computer-readable storage medium comprising instructions that, when executed by one or more processors of an additive manufacturing system, cause the additive manufacturing system to perform operations comprising:
depositing a curable material on a carrier film;
applying energy to the curable material on the carrier film to form a portion of an object;
separating the portion of the object from remaining curable material on the carrier film;
obtaining image data depicting a recess formed in the remaining curable material by the separation of the portion of the object; and
determining a geometry of the portion of the object based on the image data.

Example 44. A method comprising:
depositing a curable material on a carrier film;
applying energy to the curable material on the carrier film to form a portion of an object;
projecting a pattern onto the curable material;
obtaining image data depicting the projected pattern;
identifying a distortion in the projected pattern based on the image data; and
detecting a printing error based on the distortion.

Example 45. The method of Example 44, wherein the image data is generated by an imaging device positioned proximate to the carrier film.

Example 46. The method of Example 44 or 45, wherein the energy is applied to the curable material at a print zone of a printer assembly, and the pattern is projected onto the curable material at a location of the printer assembly downstream of the print zone.

Example 47. The method of any one of Examples 44 to 46, wherein the energy is applied to the curable material at a print zone of a printer assembly, and the pattern is projected onto the curable material at a location of the printer assembly upstream of the print zone.

Example 48. The method of any one of Examples 44 to 47, further comprising separating the portion of the object from remaining curable material on the carrier film, wherein the pattern is projected onto a recess formed in the remaining curable material by the separation.

Example 49. The method of any one of Examples 44 to 48, further comprising determining a geometry of the portion of the object based on the distortion, wherein the printing error comprises a deviation between the determined geometry and a target geometry for the portion of the object.

Example 50. The method of any one of Examples 44 to 49, wherein the printing error comprises one or more irregularities present in the curable material.

Example 51. The method of any one of Examples 44 to 50, wherein the pattern comprises one or more lines.

Example 52. The method of any one of Examples 44 to 51, further comprising adjusting a printing parameter in response to the detected printing error.

Example 53. The method of Example 52, wherein the adjustment comprises an adjustment to one or more of the following: a pattern of the applied energy, an energy dosage of the applied energy, an exposure time of the applied energy, a layer thickness of the curable material, a temperature of the curable material, a speed of the carrier film, a tension of the carrier film, or a scaling factor for the object.

Example 54. The method of Example 52 or 53, further comprising forming a subsequent portion of the object from the curable material with the adjusted printing parameter.

Example 55. The method of Example 52 or 53, further comprising terminating printing of the object in response to the detected printing error.

Example 56. The method of Example 55, wherein the printing of the object is terminated by masking the object in a digital data file used to control the application of the energy.

Example 57. The method of Example 55 or 56, further comprising continuing printing of one or more additional objects.

Example 58. The method of any one of Examples 44 to 57, wherein the curable material is transparent or translucent.

Example 59. The method of any one of Examples 44 to 58, wherein the curable material comprises a photopolymerizable resin.

Example 60. The method of any one of Examples 44 to 59, wherein the object is a dental appliance.

Example 61. A system comprising:
a carrier film configured to support a curable material;
an energy source configured to apply energy to the curable material on the carrier film to form a portion of an object on a build platform;
a light source;
an imaging device;
one or more processors; and
a memory comprising instructions that, when executed by the one or more processors,
   projecting, via the light source, a pattern onto the curable material,
   obtaining, via the imaging device, image data depicting the projected pattern,
   identifying a distortion in the projected pattern based on the image data, and
   detecting a printing error based on the distortion.

Example 62. The system of Example 61, wherein the imaging device is positioned proximate to the carrier film.

Example 63. The system of Example 61 or 62, wherein the energy is applied to the curable material at a print zone of the system, and the pattern is projected onto the curable material at a location of the system downstream of the print zone.

Example 64. The system of any one of Examples 61 to 63, wherein the energy is applied to the curable material at a print zone of the system, and the pattern is projected onto the curable material at a location of the system upstream of the print zone.

Example 65. The system of any one of Examples 61 to 64, further comprising a drive mechanism configured to cause separation of remaining curable material on the carrier film from the portion of the object, wherein the pattern is projected onto a recess formed in the remaining curable material by the separation.

Example 66. The system of any one of Examples 61 to 65, wherein the operations further comprise determining a geometry of the portion of the object based on the distortion, and wherein the printing error comprises a deviation between the determined geometry and a target geometry for the portion of the object.

Example 67. The system of any one of Examples 61 to 66, wherein the printing error comprises one or more irregularities present in the curable material.

Example 68. The system of any one of Examples 61 to 67, wherein the pattern comprises one or more lines.

Example 69. The system of any one of Examples 61 to 68, wherein the operations further comprise adjusting a printing parameter in response to the detected printing error.

Example 70. The system of Example 69, wherein the adjustment comprises an adjustment to one or more of the following: a pattern of the applied energy, an energy dosage of the applied energy, an exposure time of the applied energy, a layer thickness of the curable material, a temperature of the curable material, a speed of the carrier film, a tension of the carrier film, or a scaling factor for the object.

Example 71. The system of Example 69 or 70, wherein the operations further comprise forming a subsequent portion of the object from the curable material with the adjusted printing parameter.

Example 72. The system of Example 69 or 70, wherein the operations further comprise terminating printing of the object in response to the detected printing error.

Example 73. The system of Example 72, wherein the printing of the object is terminated by masking the object in a digital data file used to control the application of the energy.

Example 74. The system of Example 72 or 73, wherein the operations further comprise continuing printing of one or more additional objects.

Example 75. The system of any one of Examples 61 to 74, wherein the curable material is transparent or translucent.

Example 76. The system of any one of Examples 61 to 75, wherein the curable material comprises a photopolymerizable resin.

Example 77. The system of any one of Examples 61 to 76, wherein the object is a dental appliance.

Example 78. A non-transitory computer-readable storage medium comprising instructions that, when executed by one or more processors of an additive manufacturing system, cause the additive manufacturing system to perform operations comprising:
depositing a curable material on a carrier film;
applying energy to the curable material on the carrier film to form a portion of an object;
projecting a pattern onto the curable material;
obtaining image data depicting the projected pattern;
identifying a distortion in the projected pattern based on the image data; and
detecting a printing error based on the distortion.

Example 79. A method comprising:
depositing a curable material on a carrier film;
applying energy to the curable material on the carrier film to form a portion of an object;
separating the portion of the object from the carrier film;
obtaining image data depicting a deformation of the carrier film during the separation; and
determining a geometry of the portion of the object based on the image data.

Example 80. The method of Example 79, wherein the image data is generated by an imaging device positioned proximate to the carrier film.

Example 81. The method of Example 79 or 80, wherein the deformation comprises a variation in a height of the carrier film.

Example 82. The method of Example 81, wherein determining the geometry of the portion of the object comprises:
determining a height profile of the carrier film, and
correlating the height profile to the geometry of the portion of the object.

Example 83. The method of any one of Examples 79 to 82, wherein the energy is applied to the curable material at a print zone of a printer assembly, and the separation of the portion of the object occurs at a location of the printer assembly downstream of the print zone.

Example 84. The method of any one of Examples 79 to 83, wherein the carrier film is conveyed in a loop trajectory via one or more rollers, and wherein the separation of the portion of the object occurs at a location proximate to one of the one or more rollers.

Example 85. The method of any one of Examples 79 to 84, further comprising comparing the determined geometry to a target geometry for the portion of the object.

Example 86. The method of Example 85, further comprising detecting a printing error based on the comparison.

Example 87. The method of Example 86, further comprising adjusting a printing parameter in response to the detected printing error.

Example 88. The method of Example 87, wherein the adjustment comprises an adjustment to one or more of the following: a pattern of the applied energy, an energy dosage of the applied energy, an exposure time of the applied energy, a layer thickness of the curable material, a temperature of the curable material, a speed of the carrier film, a tension of the carrier film, or a scaling factor for the object.

Example 89. The method of Example 87 or 88, further comprising forming a subsequent portion of the object from the curable material with the adjusted printing parameter.

Example 90. The method of any one of Examples 86 to 88, further comprising terminating printing of the object in response to the detected printing error.

Example 91. The method of Example 90, wherein the printing of the object is terminated by masking the object in a digital data file used to control the application of the energy.

Example 92. The method of Example 90 or 91, further comprising continuing printing of one or more additional objects.

Example 93. The method of any one of Examples 79 to 92, further obtaining second image data of the curable material on the carrier film, wherein the operations further comprise adjusting a printing parameter based on the second image data.

Example 94. The method of Example 93, wherein the adjustment comprises an adjustment to one or more of the following: a pattern of the applied energy, an energy dosage of the applied energy, an exposure time of the applied energy, a layer thickness of the curable material, a temperature of the curable material, a speed of the carrier film, a tension of the carrier film, or a scaling factor for the object.

Example 95. The method of any one of Examples 79 to 94, wherein the curable material is transparent or translucent.

Example 96. The method of any one of Examples 79 to 95, wherein the curable material comprises a photopolymerizable resin.

Example 97. The method of any one of Examples 79 to 96, wherein the object is a dental appliance.

Example 98. A system comprising:
a carrier film configured to support a curable material;
an energy source configured to apply energy to the curable material on the carrier film to form a portion of an object on a build platform;
a drive mechanism configured to cause separation of the carrier film from the portion of the object;
an imaging device;
one or more processors; and
a memory comprising instructions that, when executed by the one or more processors, cause the system to perform operations comprising:
   obtaining image data depicting a deformation of the carrier film during the separation, and
   determining a geometry of the portion of the object based on the image data.

Example 99. The system of Example 98, wherein the imaging device is positioned proximate to the carrier film.

Example 100. The system of Example 98 or 99, wherein the deformation comprises a variation in a height of the carrier film.

Example 101. The system of Example 100, wherein determining the geometry of the portion of the object comprises:
determining a height profile of the carrier film, and
correlating the height profile to the geometry of the portion of the object.

Example 102. The system of any one of Examples 98 to 101, wherein the energy source is located proximate to a print zone of the system, and the separation of the portion of the object occurs at a location in the system downstream of the print zone.

Example 103. The system of any one of Examples 98 to 102, wherein the drive mechanism comprises a roller, and the separation of the portion of the object occurs at a location proximate to the roller.

Example 104. The system of any one of Examples 98 to 103, wherein the operations further comprise comparing the determined geometry to a target geometry for the portion of the object.

Example 105. The system of Example 104, wherein the operations further comprise detecting a printing error based on the comparison.

Example 106. The system of Example 105, wherein the operations further comprise adjusting a printing parameter in response to the detected printing error.

Example 107. The system of Example 106, wherein the adjustment comprises an adjustment to one or more of the following: a pattern of the applied energy, an energy dosage of the applied energy, an exposure time of the applied energy, a layer thickness of the curable material, a temperature of the curable material, a speed of the carrier film, a tension of the carrier film, or a scaling factor for the object.

Example 108. The system of Example 106 or 107, wherein the operations further comprise forming a subsequent portion of the object from the curable material with the adjusted printing parameter.

Example 109. The system of any one of Examples 105 to 107, wherein the operations further comprise terminating printing of the object in response to the detected printing error.

Example 110. The system of Example 109, wherein the printing of the object is terminated by masking the object in a digital data file used to control the application of the energy.

Example 111. The system of Example 109 or 110, wherein the operations further comprise continuing printing of one or more additional objects.

Example 112. The system of any one of Examples 98 to 111, further comprising at least one second imaging device configured to obtain second image data of the curable material on the carrier film, wherein the operations further comprise adjusting a printing parameter based on the second image data.

Example 113. The system of Example 112, wherein the adjustment comprises an adjustment to one or more of the following: a pattern of the applied energy, an energy dosage of the applied energy, an exposure time of the applied energy, a layer thickness of the curable material, a temperature of the curable material, a speed of the carrier film, a tension of the carrier film, or a scaling factor for the object.

Example 114. The system of any one of Examples 98 to 113, wherein the curable material is transparent or translucent.

Example 115. The system of any one of Examples 98 to 114, wherein the curable material comprises a photopolymerizable resin.

Example 116. The system of any one of Examples 98 to 115, wherein the object is a dental appliance.

Example 117. A non-transitory computer-readable storage medium comprising instructions that, when executed by one or more processors of an additive manufacturing system, cause the additive manufacturing system to perform operations comprising:
depositing a curable material on a carrier film;
applying energy to the curable material on the carrier film to form a portion of an object;
separating the portion of the object from the carrier film;
obtaining image data depicting a deformation of the carrier film during the separation; and
determining a geometry of the portion of the object based on the image data.

### Conclusion

Although many of the embodiments are described above with respect to systems, devices, and methods for additive manufacturing of dental appliances, the technology is applicable to other applications and/or other approaches, such as additive manufacturing of other types of objects. Moreover, other embodiments in addition to those described herein are within the scope of the technology. Additionally, several other embodiments of the technology can have different configurations, components, or procedures than those described herein. A person of ordinary skill in the art, therefore, will accordingly understand that the technology can have other embodiments with additional elements, or the technology can have other embodiments without several of the features shown and described above with reference to FIGS. 1-11.

The various processes described herein can be partially or fully implemented using program code including instructions executable by one or more processors of a computing system for implementing specific logical functions or steps in the process. The program code can be stored on any type of computer-readable medium, such as a storage device including a disk or hard drive. Computer-readable media containing code, or portions of code, can include any appropriate media known in the art, such as non-transitory computer-readable storage media. Computer-readable media can include volatile and non-volatile, removable and non-removable media implemented in any method or technology for storage and/or transmission of information, including, but not limited to, random-access memory (RAM), read-only memory (ROM), electrically erasable programmable read-only memory (EEPROM), flash memory, or other memory technology; compact disc read-only memory (CD-ROM), digital video disc (DVD), or other optical storage; magnetic cassettes, magnetic tape, magnetic disk storage, or other magnetic storage devices; solid state drives (SSD) or other solid state storage devices; or any other medium which can be used to store the desired information and which can be accessed by a system device.

The descriptions of embodiments of the technology are not intended to be exhaustive or to limit the technology to the precise form disclosed above. Where the context permits, singular or plural terms may also include the plural or singular term, respectively. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. The various embodiments described herein may also be combined to provide further embodiments.

As used herein, the terms “generally,” “substantially,” “about,” and similar terms are used as terms of approximation and not as terms of degree, and are intended to account for the inherent variations in measured or calculated values that would be recognized by those of ordinary skill in the art.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. As used herein, the phrase “and/or” as in “A and/or B” refers to A alone, B alone, and A and B. Additionally, the term “comprising” is used throughout to mean including at least the recited feature(s) such that any greater number of the same feature and/or additional types of other features are not precluded.

To the extent any materials incorporated herein by reference conflict with the present disclosure, the present disclosure controls.

It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

What is claimed is:

1. A method comprising:
depositing a curable material on a carrier film;
applying energy to the curable material on the carrier film to form a portion of an object;
separating the portion of the object from remaining curable material on the carrier film;
obtaining image data depicting a recess formed in the remaining curable material by the separation of the portion of the object; and
determining a geometry of the portion of the object based on the image data.

2. The method of claim 1, further comprising determining a geometry of the recess based on the image data, wherein the geometry of the portion of the object is determined based on the geometry of the recess.

3. The method of claim 2, further comprising projecting a pattern onto the recess and the remaining curable material, wherein the image data depicts the recess with the projected pattern thereon and the geometry of the recess is determined based on the projected pattern.

4. The method of claim 3, further comprising identifying a distortion in the projected pattern attributable to the presence of the recess, wherein the geometry of the recess is determined based on the distortion.

5. The method of claim 1, further comprising:
comparing the determined geometry to a target geometry for the portion of the object, and
detecting a printing error based on the comparison.

6. The method of claim 5, further comprising adjusting a printing parameter in response to the detected printing error.

7. The method of claim 6, wherein the adjustment comprises an adjustment to one or more of the following: a pattern of the applied energy, an energy dosage of the applied energy, an exposure time of the applied energy, a layer thickness of the curable material, a temperature of the curable material, a speed of the carrier film, a tension of the carrier film, or a scaling factor for the object.

8. The method of claim 6, further comprising forming a subsequent portion of the object from the curable material with the adjusted printing parameter.

9. The method of claim 5, further comprising terminating printing of the object in response to the detected printing error.

10. The method of claim 1, wherein the curable material is transparent or translucent.

11. A system comprising:
a carrier film configured to support a curable material;
an energy source configured to apply energy to the curable material on the carrier film to form a portion of an object on a build platform;
a drive mechanism configured to cause separation of remaining curable material on the carrier film from the portion of the object;
an imaging device;
one or more processors; and
a memory comprising instructions that, when executed by the one or more processors, cause the system to perform operations comprising:
obtaining, via the imaging device, image data depicting a recess formed in the remaining curable material by the separation, and
determining a geometry of the portion of the object based on the image data.

12. The system of claim 11, wherein the operations further comprise determining a geometry of the recess based on the image data, and wherein the geometry of the portion of the object is determined based on the geometry of the recess.

13. The system of claim 12, further comprising a light source configured to project a pattern onto the recess and the remaining curable material, wherein the image data depicts the recess with the projected pattern thereon and the geometry of the recess is determined based on the projected pattern.

14. The system of claim 13, wherein the operations further comprise identifying a distortion in the projected pattern attributable to the presence of the recess, and wherein the geometry of the recess is determined based on the distortion.

15. The system of claim 11, wherein the operations further comprise:
comparing the determined geometry to a target geometry for the portion of the object, and
detecting a printing error based on the comparison.

16. The system of claim 15, wherein the operations further comprise adjusting a printing parameter in response to the detected printing error.

17. The system of claim 16, wherein the adjustment comprises an adjustment to one or more of the following: a pattern of the applied energy, an energy dosage of the applied energy, an exposure time of the applied energy, a layer thickness of the curable material, a temperature of the curable material, a speed of the carrier film, a tension of the carrier film, or a scaling factor for the object.

18. The system of claim 16, wherein the operations further comprise forming a subsequent portion of the object from the curable material with the adjusted printing parameter.

19. The system of claim 15, wherein the operations further comprise terminating printing of the object in response to the detected printing error.

20. The system of claim 11, wherein the curable material is transparent or translucent.
